(19) United States
(12) Patent Application Publication
(10) Pub. No.: US 2026/0057243 A1
(43) Pub. Date: Feb. 26, 2026

(54) INDUCING HALLUCINATION FOR MACHINE LEARNING-BASED CONTENT RETRIEVAL

(71) Applicant: Microsoft Technology Licensing, LLC, Redmond, WA (US)

(72) Inventors: Gregory Alexander Brown, San Ramon, CA (US); William Douglas White, Eagle Creek, OR (US); Pratheek Bhat, Mountain View, CA (US); Kenneth Robinson Shih, Los Angeles, CA (US); Arjun Tarikere Ramesh, San Jose, CA (US); Christopher Jun Qian Fong, San Mateo, CA (US); Ricky Sidhu, Hayward, CA (US)

(21) Appl. No.: 18/811,620

(22) Filed: Aug. 21, 2024

(51) Int. Cl. G06N 3/094; G06N 3/0475

(52) U.S. Cl. CPC G06N 3/094; G06N 3/0475

(57) ABSTRACT

An example may provide at least one first generative machine learning model (GMLM) instruction and an intent to a GMLM. The at least one first GMLM instruction is to cause the GMLM to use the intent to generate first GMLM output. The first GMLM output includes GMLM-generated output sections. A device may provide the first GMLM output including the GMLM-generated output sections and at least one second GMLM instruction to the GMLM. The at least one second GMLM instruction is to cause the GMLM to use the intent, the GMLM-generated output sections, and a first data set to generate second GMLM output including at least one first digital element. A device may validate the second GMLM output by comparing the at least one first digital element to at least one second digital element. The at least one second digital element is accessible via a second data set.

### TECHNICAL FIELD

Technical fields to which this disclosure relates include information search and retrieval systems. Other technical fields to which this disclosure relates include applications of generative machine learning models to content retrieval tasks.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

A search engine is a software application that helps users retrieve digital content. A user provides input through a user interface. A typical search engine formulates a search based on the input, executes the search to retrieve content corresponding to the query terms, and provides the retrieved content to the user via the user interface.

Entity matching systems are computer systems that generate predictive output indicating the extent to which digital entities match or are similar to each other according to one or more criteria. For example, entity matching systems can be used to predict, based on historical data about the user's interactions with content, whether a user is likely to interact with a particular digital content item if the content item is presented to the user.

### BRIEF DESCRIPTION OF THE DRAWINGS

The disclosure will be understood more fully from the detailed description given below and from the accompanying drawings of various embodiments of the disclosure. The drawings are for explanation and understanding only and should not be taken to limit the disclosure to the specific embodiments shown.

FIG. 1 is a flow diagram of an example method for retrieving digital content in accordance with some embodiments of the present disclosure.

FIG. 2 is a flow diagram of an example method for generating a prompt in accordance with some embodiments of the present disclosure.

FIG. 3 is a flow diagram of example method for executing a prompt in accordance with some embodiments of the present disclosure.

FIG. 4 is a flow diagram of an example method for content generation and retrieval in accordance with some embodiments of the present disclosure.

FIG. 5 is an example method of a knowledge map in accordance with some embodiments of the present disclosure.

FIG. 6A, FIG. 6B, FIG. 6C, FIG. 6D, FIG. 6E, and FIG. 6F are screen captures of an example user interface flow of a computing system in accordance with some embodiments of the present disclosure.

FIG. 7A and FIG. 7B are flow diagrams of example methods for digital content retrieval in accordance with some embodiments of the present disclosure.

FIG. 8 is a block diagram of a computing system that includes a content retrieval system in accordance with some embodiments of the present disclosure.

FIG. 9A, FIG. 9B, FIG. 9C, FIG. 9D, and FIG. 9E are block diagrams of examples of machine learning models that can be used by and/or included in a content retrieval system in accordance with some embodiments of the present disclosure.

FIG. 10 is a block diagram of an example computer system including components of a content retrieval system in accordance with some embodiments of the present disclosure.

### DETAILED DESCRIPTION

Online systems are commonly used for information retrieval. In relatively simple information retrieval tasks, search results are returned in response to queries. More complex information retrieval tasks can involve additional steps to refine, augment, or optimize the query and/or to filter or sort the search results. Even more complex information retrieval tasks can include a combination of content generation and content retrieval. For example, given an intent or goal of a user, an online system can generate a multi-step plan designed to achieve the user's goal or intent and then identify digital content items that are aligned with one or more of the steps in the plan. An online system can engage in both content generation and content retrieval operations, for example, when a user's request can be decomposed into multiple smaller or more discrete requests. Examples can include requests for assistance with learning a new skill, completing a project, finding a job, or achieving a goal. For instance, when a user requests assistance with finding a job or achieving a career goal, an online system may generate a plan that includes the steps of determining the user's job requirements or career stage, identifying activities that are relevant to the job requirements or career stage, and identifying digital content items that are relevant to those activities. The step of generating the plan can include content generation. Executing the step of identifying relevant digital content items can include retrieving actionable content, such as articles, learning videos, podcasts, user connection recommendations, online or in-person event recommendations, etc., from one or more content sources (e.g., online catalogs, libraries, or databases). Actionable content may refer to digital content that is clickable or selectable to initiate an action via an online system or another electronic or physical mechanism.

Irrespective of the complexity of the content retrieval task at hand, it has been an ongoing technical challenge to maximize the relevance of retrieved content while at the same time minimizing the number of times user input is requested during query formulation. For example, users can quickly lose interest if the number of iterations on a search query or the number of dialog turns in a chat-based system is too high. Thus, it is a continuing goal of content retrieval systems to reduce or optimize the amount of user engagement needed to provide users with relevant content.

Conventional information retrieval and matching approaches are limited in their ability to generate user-personalized result sets and recommendations. For example, some conventional solutions rely on a generic, manually-curated taxonomy for matching a user's interests with available content. These approaches are not able to accommodate inexact matches and tend to return zero results in the absence of an exact match. Further, taxonomies are resource-intensive to update and maintain as information and preferences change over time.

Conventional machine learning models can be trained to generate similarity scores for pairs of entities, where an entity pair may include, for example, an embedding representing a user's preferences and an embedding representing a content item. These similarity scores can be used, for example, to determine whether to recommend a content item to a user. In these conventional systems, the embeddings are often created using structured feature sets. During training, these models develop statistical correlations between similar combinations of features. Drawbacks of these approaches include the feature engineering and model training requirements, which are resource intensive. For example, these models can become quickly out of date if not updated to reflect new data, such as changing user preferences and new topics. Additionally, it can be challenging to adapt these models to different scoring tasks. For example, a model that has been trained to output similarity scores for user profile-learning video pairs might not perform equally as well on user profile-job posting pairs.

Generative machine learning models (GMLMs), such as large language models (LLMs), have demonstrated the ability to respond to questions in a conversational natural language format using e.g., a chat or speech interface. However, it has proven challenging to ensure that responses generated by the LLMs are accurate, relevant to the questions presented, and consistently reliable. This is because the inherent nature of LLMs is that the output of the LLMs can be unpredictable due to a phenomenon known as artificial intelligence (AI) hallucination.

AI hallucination refers to the tendency of LLMs to produce irrelevant, false, inaccurate, or nonsensical information with high confidence. If not properly managed, LLM hallucinations can undermine the trust and reliability of an application system. Thus, the risk of unpredictable output by LLMs can be a deterrent to the widespread use of LLMs for content retrieval tasks.

One approach for managing AI hallucination in LLMs involves creating fine-tuned versions of pre-trained models. The fine-tuning effectively constrains the LLM by focusing the model's generation task on the training data used in the fine tuning. However, fine-tuning is resource intensive and suffers from similar problems as are encountered with the creation and maintenance of other machine learning models.

Retrieval-augmented generation (RAG) is a technique that can be used to help improve the accuracy and reliability of LLM output without the need for fine tuning of the model itself. For example, RAG can be used with LLMs that have been pre-trained on extremely large data sets, without requiring the LLMs themselves to be fine-tuned. The RAG approach retrieves information from sources external to the LLM, sometimes referred to as context, and includes the retrieved context in the LLM input (e.g., in the generation prompt) to guide or constrain the LLM''s content generation in accordance with instructions that are also included in the input to the LLM. For example, RAG can be used to query a user profile, extract details from the user profile and include those details in a generation prompt that is input to an LLM to cause the LLM to perform a resume generation task. As another example, RAG can be used to identify a library of content items that an LLM is to use for a generation or retrieval task. The information retrieved from external sources and included in an LLM input may be referred to herein as RAG input. Because the step of obtaining RAG input occurs at or prior to the providing of the input to the LLM, this approach may be referred to herein as “RAG on input.”

However, the use of RAG on input to enrich the input to the LLM's generation task requires careful structuring of the queries that provide the RAG input to the LLM and/or careful structuring of the instructions included in the LLM input to prevent AI hallucination in the LLM's output. For example, including too much or too little RAG input can cause the LLM to hallucinate and produce responses that are unusable. Another challenge is that if the RAG input is too large (e.g., contains too many records, tokens, characters, or bytes), it may exceed the technical limitations for input to the LLM.

In contrast to the conventional RAG on input approaches, some of the described examples do not use RAG on input (e.g., do not include RAG content in the generation prompt) but instead apply RAG to the GMLM output; e.g., to the output of a GMLM generation task. Some of the approaches described herein have achieved improved results by non-intuitively inducing hallucination in the GMLM's generation task and then applying RAG to the output of the GMLM's hallucinated generation task. The approaches described herein may be referred to as “RAG on output,” “hallucinated RAG,” or “reverse-RAG.”

The described reverse-RAG approaches can be used to improve GMLM-based content retrieval in many different applications while avoiding the need to fine tune the models themselves. In other words, the described approaches can be applied to pre-trained models such as commercially available or open source LLMs and thus reduce or remove the need to create and maintain fine-tuned models.

In one application, reverse-RAG is used to generate a personalized plan for a user to help the user accomplish a goal or objective. As part of the plan generation process, reverse-RAG is used to match digital elements, such as content items, to various steps, goals, or milestones in the GMLM-generated plan. The reverse-RAG approach can cause the GMLM to use the GMLM's pre-existing knowledge (e.g., training data used in the pre-training of the GMLM), but not the context of the available content items, in the generation task. Because the context for the content retrieval task (e.g., the library of available content items) is not provided to the GMLM for the task of generating the plan, the GMLM is induced to hallucinate while generating the plan. This hallucinated output is then input to a process (e.g., RAG, search, EBR, etc.) that attempts to match the hallucinated output to actual content items (e.g., digital elements accessible via a library, catalog, or database).

Examples configure one or more prompts to cause a GMLM to generate a plan for achieving a user's goal in a reliable way (e.g., with safety constraints) while leveraging the GMLM's tendency to hallucinate in a productive way. More specifically, one or more prompts can be configured to induce the GMLM to hallucinate while generating portions of the plan. The hallucinated GMLM output is input to an embedding-based retrieval (EBR) process that validates the hallucinated GMLM output by comparing the hallucinated GMLM output to actual digital content items that are available for the user's consumption e.g., via an online platform. In some examples, AI hallucination may be managed by fine tuning one or more of the prompts, e.g., by decomposing a multi-step prompt into a chain or sequence of multiple, more focused prompts, or by merging multiple prompts into a larger single prompt.

In some examples, the described approaches are used to generate a personalized learning plan for a user. A user's desired goal and career context (e.g., current role, years of experience, industry, etc.) are provided as input to a GMLM. The GMLM is instructed to use its worldly knowledge (e.g., the training data used to train the GMLM) to understand the user's current stage and career type. The GMLM is instructed to generate a plan including activities that are likely to help the user reach the desired goal. The GMLM is instructed to use the predicted activities to generate hypothetical but realistic digital elements such as content descriptions (e.g., titles or descriptions of content items) related to the activities in the plan. The GMLM is instructed to use only its knowledge (e.g., its own training data) and is not provided with any information about actual content items that may be available to assist the user with accomplishing the activities in the plan. The hypothetical elements are generated and output by the GMLM. The GMLM-generated hypothetical elements are validated and used as the basis for content retrieval. For example, the GMLM-generated hypothetical elements may be matched to actual content items using EBR or another content retrieval approach.

In some examples, one or more evaluation mechanisms evaluate the GMLM output and may iteratively refine one or more of the GMLM prompts and/or to increase or decrease the number of GMLM prompts, to improve the relevance and/or accuracy of the GMLM output and/or retrieved content included in the plan.

An advantage of the described approaches is that the amount of manual intervention required for curating content recommendations is minimized even while user- or entity-specific customization of search results is improved. Another advantage is that resource-intensive manually-curated and maintained taxonomies and labels may be replaced by the GMLM-based reverse-RAG approach. Because such taxonomies and labels are no longer needed for effective content matching, users don't need prior knowledge of the taxonomy to retrieve relevant content. As a result, the number of query iterations or dialog turns needed to return relevant results for the user can be significantly reduced (e.g., to less than or equal to three iterations or dialog turns).

A generative artificial intelligence model, generative machine learning model, or generative model uses artificial intelligence technology to machine-generate digital content based on model inputs and data with which the model has been trained. A generative language model is a particular type of generative model that is capable of generating and outputting digital content in response to model input including a task description, also referred to as a prompt.

A large language model (LLM) is a type of generative language model that is trained in an unsupervised way on massive amounts of unlabeled data, such as publicly available texts extracted from the Internet, using deep learning techniques. A language model (LM) can be similar in function and/or architecture to an LLM except that the LM may be trained on a much smaller dataset, e.g., to perform a domain-specific task. A language model or large language model can be configured to perform one or more natural language processing (NLP) tasks, such as generating content, classifying content, answering questions in a conversational manner, and translating content from one language to another.

Prompt as used herein may refer to one or more instructions that are readable by a generative artificial intelligence (GAI) model, such as a large language model. The prompt can also include or refer to the input to which the GAI model is to apply the instructions. The prompt can also include one or more parameter values configured to constrain the operations of the GAI model during the processing of the prompt and generating and outputting a response to the prompt. The input can be specified explicitly in the prompt or as a reference that is processed at execution time. The instructions can include one or more statements, questions, conditions, constraints, or examples. The examples can include examples of the types of output to be produced by the GAI model and/or examples of the types of processing steps the large language model is to perform in order to generate output.

A prompt can include natural language or multimodal instructions such as “please generate a summary of these search results” or a digital image or video recording of a demonstration of how to perform a task, for example. Alternatively or in addition, the prompt can include examples of digital content that demonstrate the type of output that the model is to produce, such as text or multimodal content (e.g., examples of digital images, videos, articles, audio, or other content produced using a particular language, format, writing style, or tone). Portions of the prompt can be in the form of natural language text, such as a question or a statement. Alternatively or in addition, a task description or prompt can include non-text forms of content, such as digital images, video, and/or digital audio. Alternatively or in addition, the prompt can include constraints, such as a specific order in which steps of a task are to be performed, specific tasks that should not be performed, and/or examples of output that should not be generated.

Prompt engineering is a technique used to optimize the structure and/or content of the input to a generative model, e.g., the prompt. Chain of thought prompting is a prompt engineering technique that causes a machine learning model to output reasoning, e.g., an explanation of how the model performed a task, such as a description of intermediate steps performed by the model to accomplish the task.

Content as used herein may refer to any type or form of digital content, including but not limited to text, imagery, video, audio, speech, recordings, streams, multimodal content, graphics, icons, hyperlinks, files, database records, etc. For instance, in some applications, content can include documents, videos, podcasts, entity profiles, web pages, or recommendations (e.g., article or video recommendations, connection recommendations, job recommendations, resource recommendations, etc.). Resource as used herein may refer to an online or offline resource, such as a software platform, application, network, or utility, or a physical resource such as an in-person training course, tool, or service.

The term entity may be used herein to refer to users and/or to other types of entities, such as companies, organizations, institutions, associations, cohorts, job postings, content items, or groups of entities. Any aspects of any embodiments that are described in the context of users can also be applied to other types of entities. Any entity can have one more associated agents that are dynamically configured for a particular role or task using the approaches described herein.

Terminology such as “real time” or “dynamic” can refer to a time delay introduced by the use of computer technology, e.g., by back end data processing and/or network transmission, where the time delay is the difference in time, as measured, e.g., by a system clock, between the occurrence of an online event and the use of data processed in response to the event, such as for display, feedback, and/or control purposes. For example, real time or dynamic can refer to a time interval between a user input to a computer system and a presentation of output by the computer system. Dynamic can also or alternatively be used herein to indicate that one or more system components, data structures or data stores, e.g., agents, workflows, databases, vector stores, memory layers, etc., are updated, reconfigured, or refreshed within a time interval that is less than the time interval between two different inputs to a computer system.

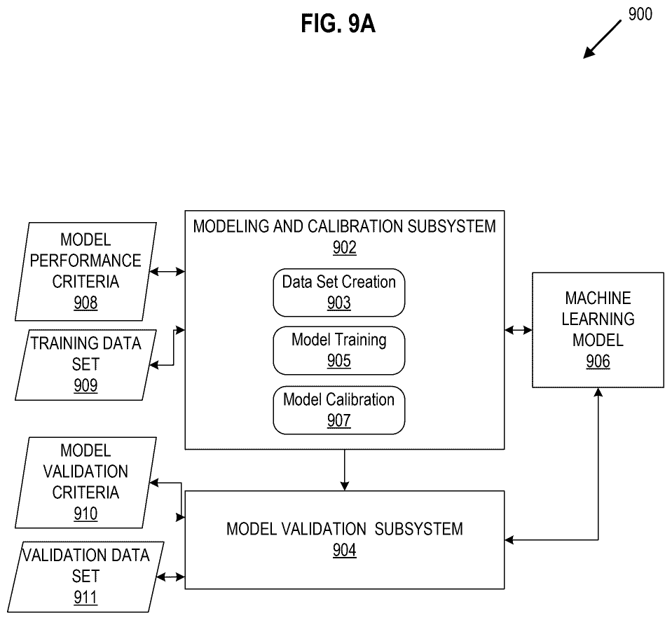

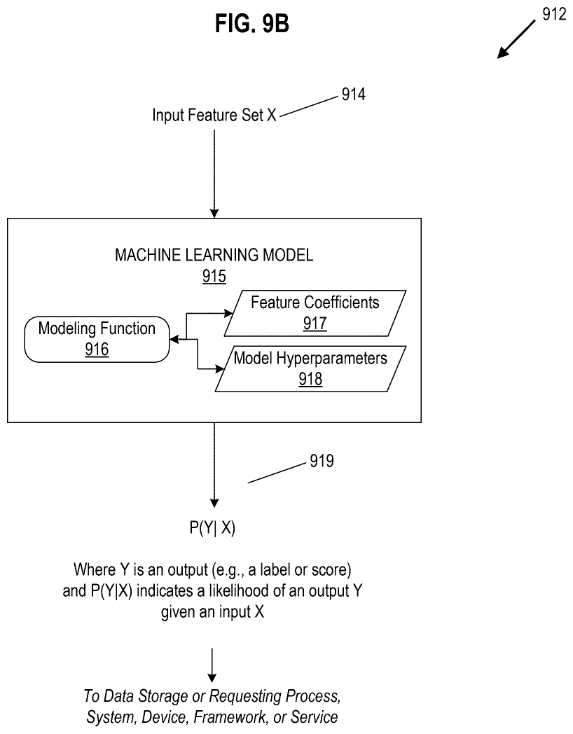

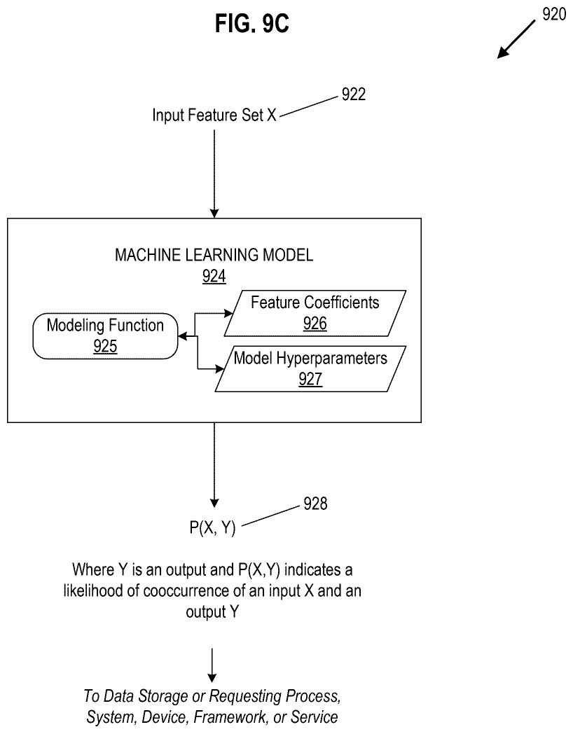

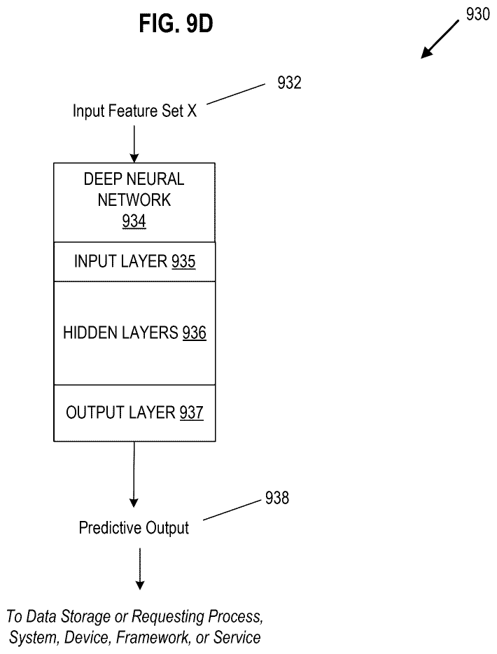

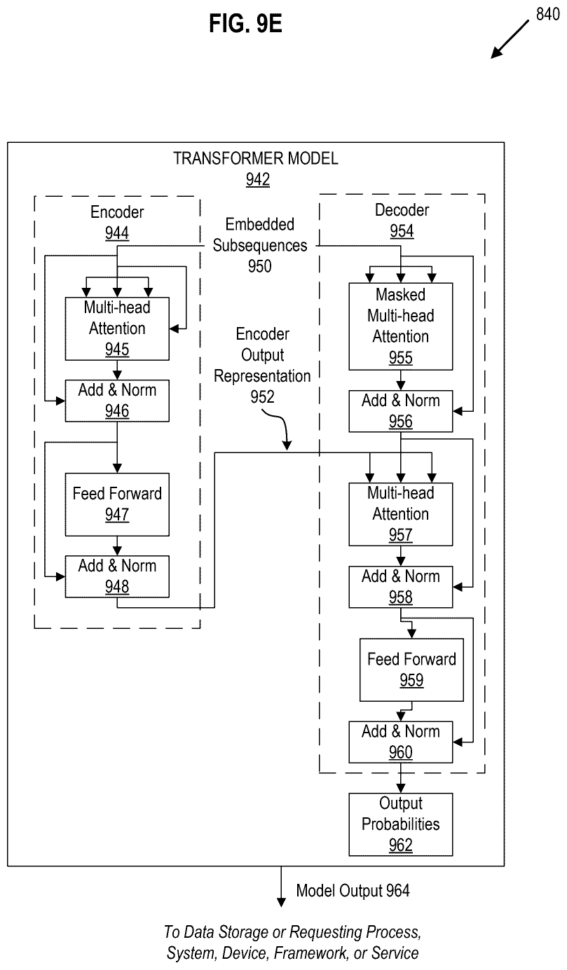

Learning, machine learning, or training can refer to machine learning-based processes that the agents use to improve their performance of tasks and achievement of goals. Examples of machine learning-based processes include processes used to configure, train, pre-train, or fine tune machine learning models, such as but not limited to supervised machine learning, semi-supervised machine learning, unsupervised machine learning, prompt engineering, reinforcement learning, in context learning, retrieval-augmented generation (RAG), retrieval-augmented fine tuning (RAFT), Chain-of-Thought reasoning, and/or Bayesian-style inference learning. For example, RAG or RAFT can be used to perform domain-specific fine tuning of a pre-trained machine learning model using, e.g., samples of digital content that represent the desired domain-specific knowledge. Using RAG, digital content can be stored in and retrieved from a data store, e.g., a database such as a vector database, using queries that are configured to measure the similarity between the digital content in the vector database and the query, question, or request being asked. For example, embedding-based retrieval can be used to match vector representations of digital content stored in a vector database with a vector representation of a query, question, or request. With in-context learning, the retrieved content is used as input to an LM or LLM, which generates a response to the input including the RAG content. In fine tuning, the RAG content can be paired with an expected output to produce a training input-output pair, which is used to fine tune the LM or LLM. Approaches such as RAFT can be used, for example, to customize an LM or LLM according to a particular entity's preferences for performing a task. Additional examples of machine learning models and machine learning-based processes are described with reference to FIG. 9A, FIG. 9B, FIG. 9C, FIG. 9D, FIG. 9E.

As used herein, dialog, chat, or conversation may refer to one or more conversational threads involving a user of a computing device and an application. For example, a dialog or conversation can have an associated user identifier, session identifier, conversation identifier, or dialog identifier, and an associated timestamp. Thread as used here may refer to one or more rounds of dialog involving the user and an application. A round of dialog as used herein may refer to a user input and an associated system-generated response, e.g., a reply to the user input that is generated at least in part via a generative artificial intelligence model. Any dialog or thread can include one or more different types of digital content, including natural language text, audio, video, digital imagery, hyperlinks, and/or multimodal content such as web pages.

Certain aspects of the disclosed technologies are described in the context of generative artificial intelligence models that receive text input and output text. However, the disclosed technologies are not limited to generative models that receive text input and produce text output. For example, aspects of the disclosed technologies can be used to receive input and/or generate output that includes non-text forms of content, such as digital imagery, videos, multimedia, audio, hyperlinks, and/or platform-independent file formats.

Certain aspects of the disclosed technologies are described in the context of electronic dialogs conducted via a network with at least one application system, such as a message- or chat-based application system or a search interface of an online system such as a social network system. However, aspects of the disclosed technologies are not limited to message- or chat-based systems or social network services, but can be used to improve various types of applications, machines, devices, and systems.

The disclosure will be understood more fully from the detailed description given below, which references the accompanying drawings. The detailed description of the drawings is for explanation and understanding, and should not be taken to limit the disclosure to the specific embodiments described.

In the drawings and the following description, references may be made to components that have the same name but different reference numbers in different figures. The use of different reference numbers in different figures indicates that components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains, but can be used with or incorporated into other embodiments, including embodiments shown in other drawings.

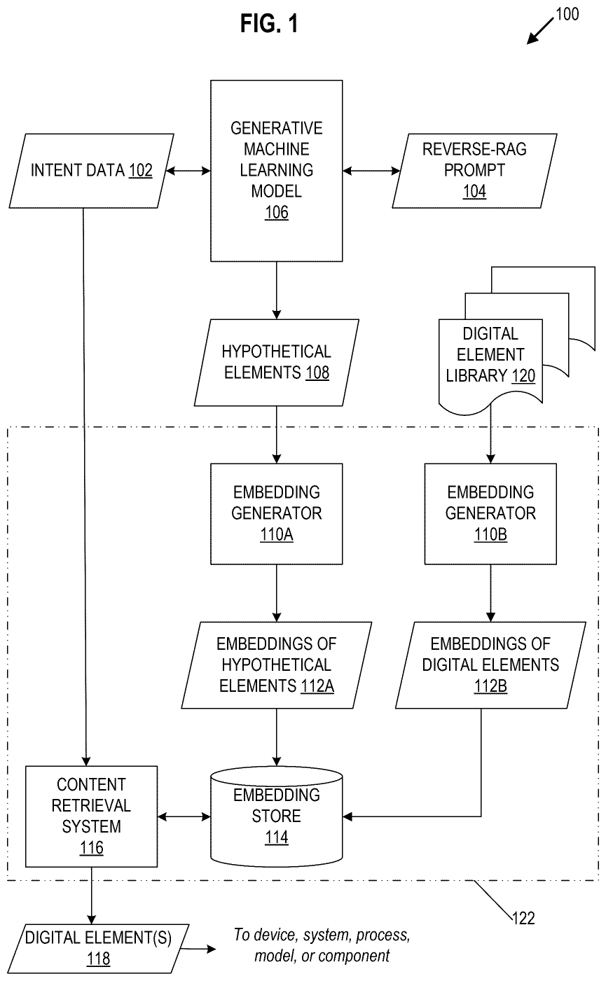

FIG. 1 is a flow diagram of an example method for retrieving content in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of a content generation and retrieval system, including, in some embodiments, components or flows shown in FIG. 1 that may not be specifically shown in other figures and/or including, in some embodiments, components or flows shown in other figures that may not be specifically shown in FIG. 1. Although shown in a particular sequence, arrangement, or order, unless otherwise specified, the order and/or arrangement of the components and/or processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In FIG. 1, components of an example computing system 100 including a content generation and retrieval system are shown, including a generative machine learning model 106, one or more embedding generators 110A, 110B, an embedding store 114, a content retrieval system 116, and a digital element library 120.

The generative machine learning model (GMLM) 106 can generate and output digital content in response to input. The GMLM can perform other tasks, such as embedding generation and/or classification, in addition to generation tasks. The GMLM can be implemented as a language model, such as large language model, e.g., a pre-trained domain-independent LLM that is not fine-tuned for any particular generation task. The GMLM 106 can be implemented as a service, for example via a hosted platform on a network. The GMLM 106 can be accessed and used via one or more application program interfaces (APIs). Examples of generative models and machine learning model training are described, for example, with reference to FIG. 9A, FIG. 9B, FIG. 9C, FIG. 9D and/or FIG. 9E.

The one or more embedding generators 110A, 110B can generate and output embeddings in response to input. For example, the one or more embedding generators 110A, 110B can generate and output compressed representations, e.g., vector representations, of inputs. The one or more embedding generators 110A, 110B can be implemented as GMLMs or other types of machine learning models. The one or more embedding generators 110A, 110B can be the same embedding generator or similar embedding generators that generate and output embeddings over the same vector space. For example, one or more embedding generators 110A, 110B can be implemented as the GMLM 106, which receives one or more instructions (e.g., one or more embedding generation prompts), which cause the GMLM 106 to function as an embedding generator for purposes of performing the operations of the one or more embedding generators 110A, 110B.

The embedding store 114 can store embeddings generated and output by the one or more embedding generators 110A, 110B. The embedding store 114 can be implemented as one or more data stores, e.g., vector databases. The contents of the embedding store 114 can be indexed to facilitate embedding retrieval.

The content retrieval system 116 can execute queries on the embedding store 114 to identify and/or retrieve digital elements in response to input. The content retrieval system 116 can be implemented using one or more similarity algorithms, such as a nearest neighbor algorithm, to identify similar digital elements based on comparisons of their respective embeddings via the one or more similarity algorithms. In combination with the one or more embedding generators 110A, 110B and the embedding store 114, the content retrieval system 116 can be part of an embedding-based retrieval (EBR) subsystem 122.

The digital element library 120 can store digital elements such as content items, e.g., documents, videos, podcasts, web pages, recommendations, events, etc., which may be identified and retrieved via the computing system 100. The digital element library 120 can be implemented as one or more data stores, e.g., graph databases, key-value stores, etc. The contents of the digital element library 120 can be indexed to facilitate retrieval of digital elements.

In operation, the GMLM 106 receives input including intent data 102 and reverse-RAG prompt 104. The intent data 102 includes one or more criteria that relate to a generation and/or retrieval task. For example, the intent data 102 can include user input, such as a question or request, e.g., “how can I become a master chef?” Alternatively or in addition, the intent data 102 can include attribute and/or activity data related to a user, such as information about the user's skills and/or recent activities, which may be extracted from the user's online profile.

The reverse-RAG prompt 104 includes one or more instructions that are configured to cause the generative machine learning model 106 to generate and output hypothetical elements 108 based on the intent data 102. The one or more instructions included in the reverse-RAG prompt 104 can include human readable natural language text and/or other forms of human perceivable digital content such as digital images, audio, or video. For instance, examples of the reverse-RAG prompt 104 may not include any computer programming code or embeddings.

Examples of the reverse-RAG prompt 104 include one or more instructions that are configured to induce the GMLM 106 to hallucinate while generating the hypothetical elements 108. For instance, the reverse-RAG prompt 104 may omit any reference to the digital element library 120 or the domain or type of content contained in the digital element library 120, or the reverse-RAG prompt 104 prompt may instruct the GMLM 106 to exclude the digital element library 120 when generating the hypothetical elements 108. As another example, the reverse-RAG prompt 104 may include one or more specific instructions configured to cause the GMLM 106 to use its “worldly knowledge,” e.g., the complete set of data on which the GMLM 106 has been trained (but excluding the digital element library 120), to generate the hypothetical elements 108.

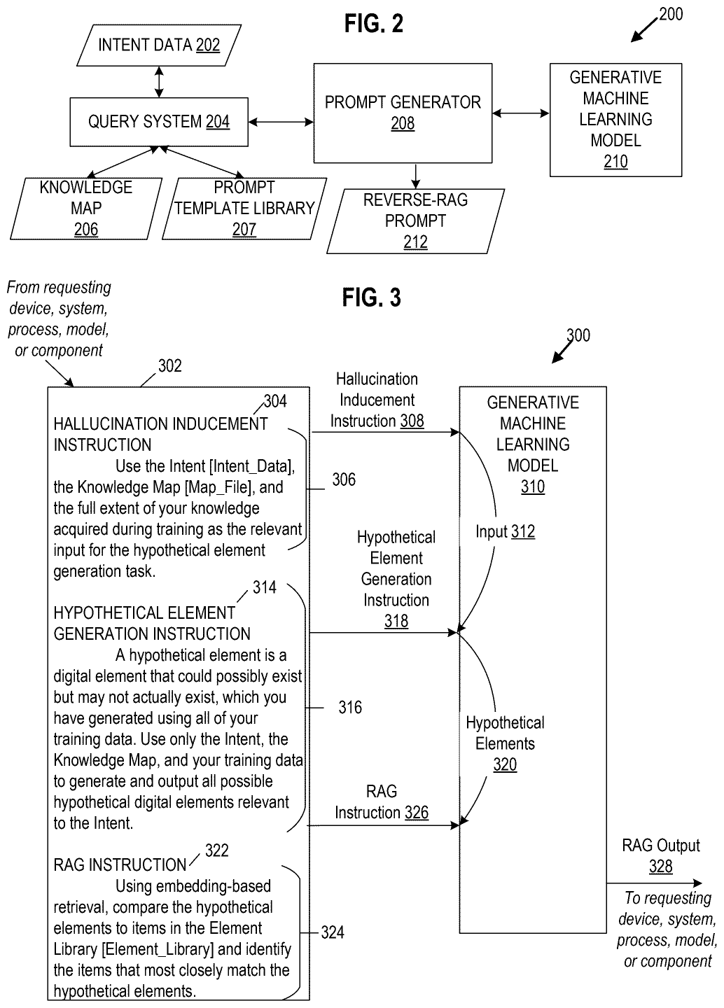

The reverse-RAG prompt 104 can include or reference the intent data 102. For example, the reverse-RAG prompt 104 can include or be created using a template having one or more placeholders, e.g., arguments, that are replaced with portions of the intent data 102 before the reverse-RAG prompt 104 is input to the GMLM 106. The template used to formulate the reverse-RAG prompt 104 can be selected based on the intent data 102. For instance, a prompt template can be selected from a library of stored templates in accordance with the intent data 102, e.g., different prompt templates can be used for different intents. For example, different prompt templates may be used to create the reverse-RAG prompts 104 for different applications (e.g., a first prompt template for generating plans, a second prompt template for suggesting relevant content corresponding to an intent, etc.). An example of an approach for generating the reverse-RAG prompt 104 is described, for instance, with reference to FIG. 2. An example of a reverse-RAG prompt 104 and its processing by a GMLM is described, for instance, with reference to FIG. 3.

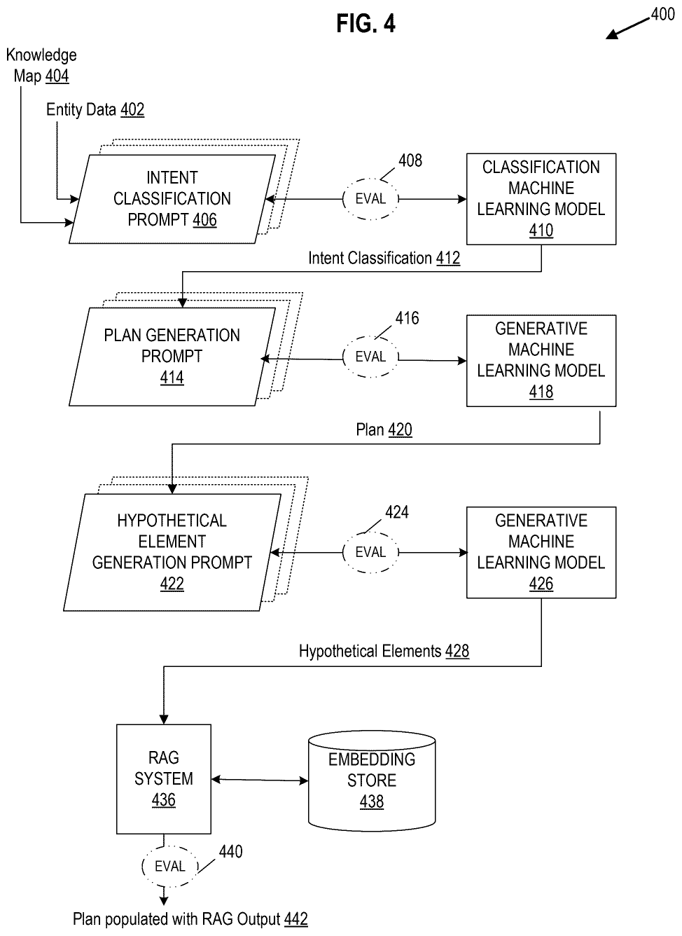

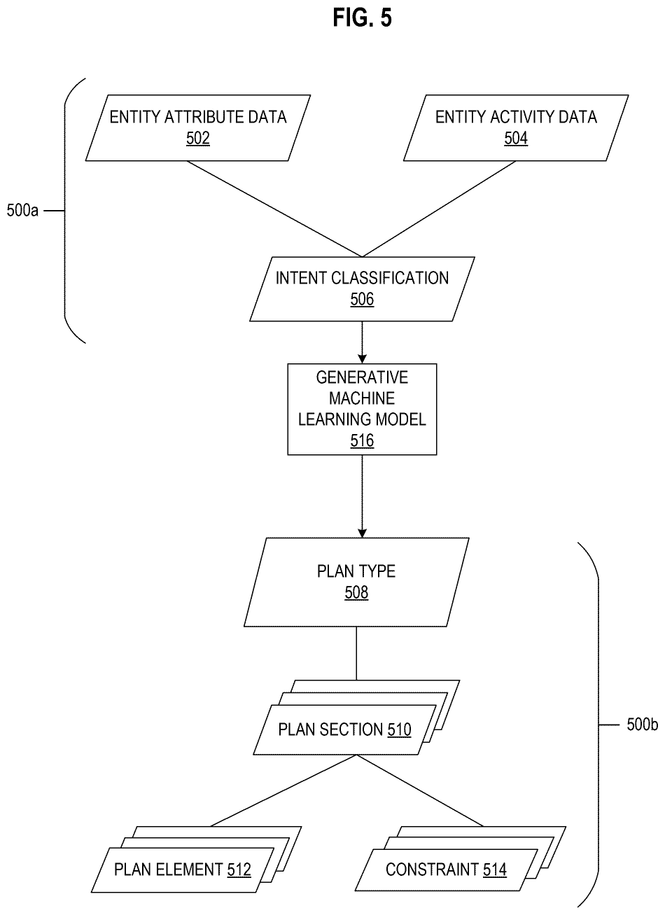

Some examples include a knowledge map as input to the GMLM 106 (e.g., as part of or referenced in the reverse-RAG prompt 104) or configure the GMLM 106 according to a knowledge map (e.g., the knowledge map is included in or referenced by a config file for the GMLM). Examples that include a knowledge map are described with reference to FIG. 2, FIG. 3, and FIG. 4, and an example of a knowledge map is shown in FIG. 5. Use of a knowledge map is not required in all examples.

In operation, the GMLM 106 processes the input including the intent data 102 and the reverse-RAG prompt 104, and generates and outputs hypothetical elements 108 in response to the input. The hypothetical elements 108 include digital elements that are generated by the GMLM in response to the reverse-RAG prompt 104 and the intent data 102. The hypothetical elements 108 are hypothetical in the sense that they are generated by the GMLM 106 without the GMLM 106 having any access to or knowledge of the digital element library 120. For example, the GMLM 106 may be a general-purpose pre-trained GMLM that is not fine-tuned for any specific domain and therefore is not trained or fine-tuned based on the digital element library 120. As a result, the hypothetical elements 108 generated by the GMLM 106 in response to the reverse-RAG prompt 104 are digital elements that could possibly exist in the digital element library 120 but may not actually exist in the digital element library 120. In other words, the hypothetical elements 108 are generated by the GMLM 106 based on the training data used to train the GMLM 106 as context (and without using the digital element library 120 as context).

Examples of hypothetical elements 108 include hypothetical descriptions of digital content items. For instance, hypothetical elements 108 can include human readable or human perceivable (e.g., natural language text, audio, or video) titles and/or descriptions of digital content items that possibly could be stored in the digital element library 120.

In some examples, such as the example described with reference to FIG. 4, the reverse-RAG prompt 104 includes or is preceded by one or more other prompts that cause the GMLM 106 to execute one or more additional tasks prior to the generation of the hypothetical elements 108. For instance, the GMLM 106 may be tasked with generating and outputting a plan including plan sections, and the plan and/or plan sections may be included as additional input to the reverse-RAG prompt 104, such that the resulting hypothetical elements 108 are generated by the GMLM 106 based on the intent data 102, the reverse-RAG prompt 104, and the plan and/or one or more plan sections.

The hypothetical elements 108 are provided to the EBR subsystem 122. For example, the hypothetical elements 108 are input to the embedding generator 110A. The embedding generator 110A generates and outputs a compressed representation (e.g., embeddings 112A) for each of the hypothetical elements 108. The embeddings of the hypothetical elements 112 may be stored in the embedding store 114.

The digital elements contained in the digital element library 120 include actual (e.g., non-hypothetical) digital elements that can be accessed by users via an online system, e.g., articles, posts, events, recommendations, videos, audio recordings, etc. The embedding generator 110B generates and outputs a compressed representation (e.g., embeddings 112B) for each of the digital elements in the digital element library 120. The embeddings of the hypothetical elements 112B may be stored in the embedding store 114. The embeddings of hypothetical elements 112B and the embeddings of digital elements 112B can be generated using the same embedding space (e.g., by the same or similarly-configured embedding generator) to facilitate embedding-based retrieval.

In response to the intent data 102, content retrieval system 116 retrieves digital elements 118 from digital element library 120 using a RAG-based approach. For example, the content retrieval system 116 can formulate a prompt to cause the GMLM 106 to perform embedding-based retrieval using the embeddings of hypothetical elements 112A and the embeddings of digital elements 112B, stored in the embedding store 114, and identify the embeddings of digital elements 112B that most closely match the embeddings of hypothetical elements 112A according to one or more similarity criteria. The similarity criteria and thresholds for determining whether a match is found are configurable based on the requirements or design of the computing system 100 or content retrieval system 110. In this way, the content retrieval system 116 effectively validates the hypothetical elements 108 by comparing the hypothetical elements 108 or their respective embeddings to the digital elements contained in the digital element library 120 (or their respective embeddings).

The content retrieval system 116 outputs digital elements 118 that satisfy the applicable one or more similarity criteria with respect to the hypothetical elements 108, for use by one or more devices, systems, processes, models, or components. For example, digital elements 118 that have been determined to match one or more of the hypothetical elements 108 are provided to one or more devices for inclusion in one or more user interfaces. For example, digital elements 188 can be provided for inclusion in a presentation of search results or a presentation of a GMLM-generated plan, at one or more devices.

The examples shown in FIG. 1 and the accompanying description, above are provided for illustration purposes. This disclosure is not limited to the described examples. Additional or alternative details and implementations are described herein.

FIG. 2 is a flow diagram of an example method for generating a prompt in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of a content generation and retrieval system, including, in some embodiments, components or flows shown in FIG. 2 that may not be specifically shown in other figures and/or including, in some embodiments, components or flows shown in other figures that may not be specifically shown in FIG. 2. Although shown in a particular sequence, arrangement, or order, unless otherwise specified, the order and/or arrangement of the components and/or processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In FIG. 2, an example computing system 200 is shown, which can automate the processes of formulating, configuring, or creating GMLM prompts. Computing system 200 includes a prompt generator 208, a query system 204, and a generative machine learning model (GMLM) 210. Examples of the prompt generator 208 can be implemented as a programmable function or tool. For instance, the prompt generator 208 can include a computer program component that creates, configures, or formulates an instruction to cause the generative machine learning model 210 to generate and output a reverse-RAG prompt 212. That is, prompt generator 208 may interface with the generative machine learning model 210 to perform one or more of the following: obtain and/or classify the intent data 202; generate a prompt generation prompt (e.g., an intermediate prompt that includes one or more instructions to cause the GMLM 210 to generate and output reverse-RAG prompt 21) using the intent classification, and execute the prompt generation prompt to create the reverse-RAG prompt 212. These generation tasks can be accomplished using a single, multi-step prompt or multiple, single-step prompts, for example.

The query system 204 can be implemented using, e.g., a database query system for, e.g., a vector database or graph database. For example, the query system 204 can use, e.g., embedding-based retrieval or graph queries to retrieve intent data 202 from one or more data sources (e.g., user input received via a user interface, a log of conversation history or state transitions, dialog context, user profiles, etc.). The query system 204 can provide the intent data 202 to prompt generator 208. Alternatively or in addition, the query system 204 can identify or retrieve a knowledge map 206 from a data store and provide the knowledge map 206 to prompt generator 208.

The generative machine learning model 210 can be implemented using, e.g., a pre-trained generative machine learning model, such a language model, e.g., an LLM, or another type of generative machine learning model.

The knowledge map 206 can be implemented using, e.g., a data model, a graph, a key-value data store, or a config file for the GMLM 210. For example, the knowledge map 206 can provide the GMLM 210 with instructions and/or rules regarding data types and relationships between data types. For instance, the knowledge map 206 can specify relationships between user attributes and/or activities and career stages or goals. The knowledge map 206 may be used by prompt generator 208 to classify the intent data 202 and/or to constrain the GMLM generation tasks. Providing the knowledge map 206 to the GMLM 210 as a config file can improve the performance and/or efficiency of the GMLM 210 without the need to fine-tune the GMLM 210. Use of the knowledge map 206 may be optional and not all examples may use a knowledge map 206. An example of a knowledge map 206 is described with reference to FIG. 5.

In operation, the prompt generator 208 obtains intent data 202 from one or more data sources via query system 204. The intent data 202 can include user input such as a goal, task, or topic of interest. In some examples, prompt generator 208 may execute a query to obtain portions of the intent data 202 from one or more data sources such as user profile databases and/or historical activity data, to be used as context (e.g., without using RAG). For example, prompt generator 208 may execute a search query to obtain user attribute and/or activity data from one or more user profiles and cause the GMLM 210 to use the knowledge map 206 to select or filter the user attribute and/or activity data to include in the intent data 202 . . . . In some examples, RAG may be used to supplement the user's context, for example to provide information from the user's profile and/or activity log to the GMLM 210 for the purpose of improving the intent determination. This approach of using “RAG on input” to supplement the user's input to the intent classification process, for example, would be limited to the user's context and would not involve querying the content library that contains the digital items that could be recommended to the user in response to the intent. In other words, the GMLM would not have access to the content library or would be instructed not to include the content library in the intent determination process or the hypothetical element generation process. Thus, some examples may use RAG to obtain or supplement user context for intent determinations and this use of RAG on input is distinguished from the reverse-RAG approach for validating the output of the GMLM.

In some examples, prompt generator 208 may use a classification instruction and the knowledge map 206 to cause the GMLM 210 to perform the task of classifying the intent data 202, e.g., to assign a standardized intent label or data type to the intent data 202. In other examples, intent classification may be performed using another approach, such as a rule-based approach, a decision tree, a regression-based classifier, or another type of machine learning model.

The prompt generator 208 provides the intent data 202 (and, in some examples, an intent classification and/or the knowledge map 206) to the generative machine learning model 210 with an instruction to generate a reverse-RAG prompt. The generative machine learning model 210 processes the instruction in combination with the intent data 202 and the knowledge map 206 to generate and output the reverse-RAG prompt 212. For example, the generative machine learning model 210 combines or merges the intent data 202 with a reverse-RAG prompt template, which may be selected from a prompt template library 207, in accordance with the knowledge map 206 to create or configure the reverse-RAG prompt 212. An example of a reverse-RAG prompt is described with reference to FIG. 3. The generative machine learning model 210 provides the reverse-RAG prompt 212 to prompt generator 208.

The prompt generator 208 outputs the reverse-RAG prompt 212 to, e.g., a process, model, agent, or other component of an application system such as a content generation and retrieval system. For example, the prompt generator 208 can be called by a requesting system, such as a content generation and retrieval system, and return the reverse-RAG prompt 212 to the requesting system. The requesting system can then provide the reverse-RAG prompt 212 to a second machine learning model (e.g., the generative machine learning model 210 or a different machine learning model) for execution by the second machine learning model. In other examples the reverse-RAG prompt 212 is not returned to the requesting system but rather is provided directly to the machine learning model (e.g., the machine learning model 210).

The examples shown in FIG. 2 and the accompanying description, above are provided for illustration purposes. This disclosure is not limited to the described examples. Additional or alternative details and implementations are described herein.

FIG. 3 is a flow diagram of example method for executing a prompt in accordance with some embodiments of the present disclosure.

The method 300 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of content generation and retrieval system, including, in some embodiments, components or flows shown in FIG. 3 that may not be specifically shown in other figures and/or including, in some embodiments, components or flows shown in other figures that may not be specifically shown in FIG. 3. Although shown in a particular sequence, arrangement, or order, unless otherwise specified, the order and/or arrangement of the components and/or processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In FIG. 3, an example of a reverse-RAG prompt 302 is shown. The reverse-RAG prompt 302 can be generated and output using a prompt generation process such as described with reference to FIG. 2 or another suitable process. In operation, a requesting device, system, process, model or component provides the reverse-RAG prompt 302 to a generative machine learning model (GMLM) 310. For example, a content generation and retrieval system generates, formulates, or configures the reverse-RAG prompt 302 in response to user input received via device, where the user input may include, for instance, a request for assistance with a job search or with developing a learning plan.

In the example of FIG. 3, the method 300 illustrates how a generative machine learning model 310 can be applied to and process a reverse-RAG prompt 302. The generative machine learning model 310 can be implemented using, e.g., a pre-trained or fine-tuned generative machine learning model, such as an LLM, an LM, or another type of generative model. The generative machine learning model 310 processes the reverse-RAG prompt 302 by executing the instructions contained in the reverse-RAG prompt 302.

The reverse-RAG prompt 302 includes one or multiple instructions or instruction sections, including a hallucination inducement instruction 304, a hypothetical element generation instruction 314, and a RAG instruction 322. Each of the instructions 304, 314, 324 has a corresponding instruction body 306, 316, 324, which can one or more instructions, statements, and/or examples of the types of output the GMLM 310 is to generate. In some examples, the instructions 304, 314, 322 are included in a single prompt (e.g., in a single communication or API call to the GMLM 310). In other examples, the instructions 304, 314, 322 are each included in a separate communication or API call to the GMLM 310. Also or alternatively, in some examples, one or more of the instructions 304, 314, 322 can be further decomposed into more discrete (e.g., single task) prompts or expanded into more complex (e.g., multi-task) prompts.

The example instructions 304, 314, 322 are in the form of natural language text. In other examples, one or more of the instructions 304, 314, 322 can include non-text content or multimodal content, alternatively or in addition to text. The instructions 304, 314, 322 are illustrative and nonlimiting. Other alternative word choices or methods of expressing the concepts described by the instructions 304, 314, 322 are used in other examples.

The hallucination inducement instruction 304 is configured to induce AI hallucination by the GMLM 310 during the process of generating hypothetical elements. For example, the hallucination inducement instruction 304 includes specific language such as “use the full extent of your knowledge acquired during training,” which is intended to induce hallucination. The hallucination inducement instruction 304 also instructs the GMLM 310 to use intent data (e.g., intent data 202) and a knowledge map (e.g., knowledge map 206) as the input 312 for the hypothetical element generation task. The hallucination inducement instruction 304 is parameterized so that the intent data and/or the knowledge map may be omitted in some examples, depending on the requirements of a particular design or implementation.

The hallucination inducement instruction 304 is passed or otherwise provided to the GMLM 310 via one or more hallucination inducement instruction communications 308 (e.g., API calls). The GMLM 310 receives and processes the one or more hallucination inducement instruction communications 308. In response to the hallucination inducement instruction 306, the GMLM 310 obtains input 312 and provides the input 312 as context for the hypothetical element generation instruction 314. Alternatively, the hallucination inducement instruction 304 is included in the hypothetical element generation instruction 314. For example, the hypothetical element generation instruction 314 can include both instruction body 306 and instruction body 316.

The hypothetical element generation instruction 314 is configured to cause the GMLM 310 to generate and output hypothetical elements using the input 312 and the GMLM 310's corpus of training data (e.g., the corpus of content used to train a pre-trained LLM). For example, the hypothetical element generation instruction 314 includes specific language such as “use only the Intent, the Knowledge Map, and your training data to generate and output all possible hypothetical digital elements relevant to the Intent,” portions of which (e.g., “all possible”) are intended to induce hallucination by the GMLM 310 during generation of hypothetical elements. The capitalized terms (e.g., Intent, Knowledge Map) are references to the parameterized data included in the Input 312.

The specification that “only” the described sources be used, or similar language, may be included to cause the GMLM 310 to omit or exclude any other content sources besides those specified that may be accessible to the GMLM 310. Examples of such other content sources that may be explicitly excluded from the hypothetical element generation task can include data sets used to fine tune the GMLM 310, content libraries such as digital element library 120, and embedding stores such as embedding store 114.

The hypothetical element generation instruction 314 is passed or otherwise provided to the GMLM 310 via one or more hypothetical element generation communications 318 (e.g., API calls). The GMLM 310 receives and processes the one or more hypothetical element generation communications 318. In response to the hallucination inducement instruction 314, the GMLM 310 generates and outputs hypothetical elements 320 and provides the hypothetical elements 320 as input for RAG instruction 322. Examples of hypothetical elements 320 include digital elements, such as content items, titles of content items, or descriptions of content items (e.g., captions, summaries, etc.), which are generated by the GMLM 310 using the approaches described.

The RAG instruction 322 is configured to cause the GMLM 310 to execute a retrieval-augmented generation (RAG) process on the GMLM output to validate the hypothetical elements 320 by attempting to match the hypothetical elements 320 with digital elements in a digital element library (e.g., digital element library 120) using an EBR-based approach. Thus, RAG is employed on the output, that is after the GMLM 310 has generated and output the hypothetical elements 320, RAG is used to validate the hypothetical elements 320 by matching them to actual digital elements that are available for user consumption via an online system via EBR. That is, hypothetical elements 320 are validated if the difference between their embeddings and embeddings of actual available digital elements meets or exceeds an applicable similarity threshold, which may be set and adjusted based on the requirements of a particular design or implementation.

The RAG instruction 322 is passed or otherwise provided to the GMLM 310 via one or more RAG instruction communications 326 (e.g., API calls). The GMLM 310 receives and processes the one or more RAG instruction communications 326. In response to the RAG instruction 322, the GMLM 310 executes RAG instruction 322 using at least hypothetical elements 320 to produce RAG output 328. The generative machine learning model 310 returns the RAG output 328 to the calling program, agent, component, service, or system, e.g., to the content generation and retrieval system. For instance, the RAG output 328 is included by the content generation and retrieval system in a presentation of search results, recommendation, or a plan. Examples of RAG output 328 include retrievable digital content items that match the hypothetical elements 320, such as articles, videos, podcasts, images, entity profiles, connection recommendations, event recommendations, or any type of content item that can be compared with the hypothetical elements 320 via EBR.

The examples shown in FIG. 3 and the accompanying description, above are provided for illustration purposes. This disclosure is not limited to the described examples. Additional or alternative details and implementations are described herein.

FIG. 4 is a flow diagram of an example method for content generation and retrieval in accordance with some embodiments of the present disclosure.

The method 400 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of a content generation and retrieval system, including, in some embodiments, components or flows shown in FIG. 4 that may not be specifically shown in other figures and/or including, in some embodiments, components or flows shown in other figures that may not be specifically shown in FIG. 4. Although shown in a particular sequence, arrangement, or order, unless otherwise specified, the order and/or arrangement of the components and/or processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

FIG. 4 illustrates an example application of the described reverse-RAG approach to a content generation and retrieval task such as generating and outputting a plan that includes both GMLM-generated content and retrieved content items.

In the example of FIG. 4, portions of the method 400 are performed using a classification machine learning model 410, a generative machine learning model 418, a generative machine learning model 426, a RAG system 436, an embedding store 438, and one or more evaluation components 408, 416, 424.

The classification machine learning model 410 can be implemented, for example, using a discriminative model such as a regression model or a generative model configured to perform a classification task. Any of the generative machine learning models described herein, including the generative machine learning models 418, 426, can be implemented, for example, using a sequence to sequence model, an encoder-decoder model, a transformer model, or another type of generative machine learning model. In some embodiments, the generative machine learning model 418 is implemented using a pre-trained language model, such as a large language model with reasoning capabilities. Any or all of the models 410, 418, 426 may be implemented using the same machine learning model or different machine learning models.

The RAG system 436 includes a query and content retrieval system that is implemented using an embedding-based retrieval approach. The embedding store 438 includes one or more data stores, e.g., vector databases, that store embeddings, e.g., compressed representations of digital elements. The embedding store 438 can include embeddings of digital elements stored, for example, in digital element library 120 and embeddings of hypothetical elements 428.

The one or more evaluation components 408, 416, 424 can be implemented, for example, using one or more discriminative machine learning models or generative machine learning models. For example, the one or more evaluation components 408, 416, 424 can be the same as the machine learning model used as the classification machine learning model 410 or the machine learning model used as the generative machine learning models 418, 426. In some embodiments, the same machine learning model is used to perform the functions of each of the classification machine learning model 410, the generative machine learning models 418, 426, and the one or more evaluation components 408, 416, 424.

In operation, input including a knowledge map 404 and entity data 402 is received from, e.g., a requesting device, application, process, component, or system, such as a content generation and retrieval system implemented using, for instance, a conversational agent. The entity data 402 can include one or more of user input, such as natural language input and/or option selections received via a conversational user interface, or context data. Context data can include, for example, one or more portions of a log of previously received user input, state history of the conversational agent, conversational dialog history, and/or other information associated with a source of input, such as online profiles and/or online activities (e.g., content posts, social reactions, search histories, content shares, connection requests, etc.) associated with the source of input.

The knowledge map 404 can include rules and/or constraints as to relationships between different types of data. The knowledge map can be implemented as a graph, table, database, or config file, for instance. For example, the knowledge map 404 can include a configuration file for one or more of the machine learning models 410, 418, 426. Use of a knowledge map 404 as a configuration file for a GMLM can accelerate the process of prompt engineering and/or reduce the need for fine tuning of the GMLM itself. An example of a knowledge map is described with reference to FIG. 5.

The input including the knowledge map 404 and entity data 402 is used to configure an intent classification prompt 406. For example, portions of the input can be merged or combined with an intent classification prompt template to create the intent classification prompt 406. For instance, an intent classification prompt template can be selected from a library of prompt templates based on the entity data 402 and/or knowledge map 404. The intent classification prompt contains one or more instructions to cause the classification machine learning model 410 to, e.g., extract one or more entities from the entity data 402 and use e.g., binary classification, to classify the entity data 402 into a standardized intent type or category based on the extracted one or more entities. In some implementations, such as where the classification machine learning model 410 is a binary classifier, the intent classification prompt 406 can be omitted and the entity data 402 and/or features extracted from the entity data 402 can be input directly into the classification machine learning model 410 (e.g., without a classification prompt 406).

The classification machine learning model 410 processes the intent classification prompt 406 and outputs an intent classification 412. The intent classification 412 can include, e.g., a compact representation of the entity data 402, such as a canonical representation of an action or user intention contained in the entity data 402. For instance, the intent classification 412 can include an action category, such as job search, learning plan, assess job, update profile, etc.

In some embodiments, an evaluation component 408 can be applied to the intent classification 412 before the intent classification 412 is included in the plan generation prompt 414. For example, evaluation component 408 can evaluate the intent classification 412 based on the degree to which it matches similar combinations of historical data, e.g., historical combinations of entity data 402 and intent classifications 412 that have received positive user feedback or “golden” combinations of entity data and intent classifications that have been manually curated. If the intent classification 412 does not meet or exceed the one or more applicable evaluation criteria, the intent classification prompt 406 may be further decomposed into more discrete prompts and then resubmitted to the classification machine learning model 410. This process of evaluating the intent classification 412 and modifying the intent classification prompt 406 can be repeated iteratively until the applicable evaluation criteria are met or exceeded. As such, the dotted-line and dot-dash lines in FIG. 4 indicate that there may be one or multiple intent classification prompts 406 and/or zero or more iterations of the evaluation component 408.

The intent classification 412 is used to configure a plan generation prompt 414. For example, the intent classification 412 can be merged or combined with a plan generation prompt template to create the plan generation prompt 414. The plan generation prompt 414 contains one or more instructions to cause the generative machine learning model 418 to generate and output a plan 420. For example, the plan generation prompt 414 includes an instruction to cause the generative machine learning model 418 to use the intent classification 412 to generate a first draft of a plan 420, where the plan 420 may include a list, group, or sequence of steps, tasks, items, and/or milestones that are part of the plan 420. For instance, if the intent classification 412 is to assist the user in switching careers, the plan 420 may include a list of action items generated by the GMLM 418 based on the intent classification 412, such as update resume, take online course, conduct job search, etc. The items in the plan 420 may be ordered according to an ordering criteria such as chronological or based on dependencies or prerequisites between plan elements. The plan 420 does not include the hypothetical elements 428. Instead, in the described example, the plan 420 is used as input (e.g., context) for the GMLM 426 to generate and output hypothetical elements 428. Portions of the plan 420 can be configured by generative machine learning model 418 for presentation via a user interface and modified based on user input and/or feedback.

In some embodiments, an evaluation component 416 can be applied to the plan 420 before the plan 420 is included in the hypothetical element generation prompt 422. For example, evaluation component 416 can evaluate the plan 420 based on the degree to which it matches similar combinations of intent classifications 412 and plans 420 that have received positive user feedback or “golden” combinations of intent classifications and plans that have been manually curated. If the plan 420 does not meet or exceed the one or more applicable evaluation criteria, the plan generation prompt 414 may be further decomposed into more discrete prompts and then resubmitted to the generative machine learning model 418. This process of evaluating the plan 420 and modifying the plan generation prompt 414 can be repeated iteratively until the applicable evaluation criteria are met or exceeded. As such, the dotted-line and dot-dash lines in FIG. 4 indicate that there may be one or multiple plan generation prompts 414 and/or zero or more iterations of the evaluation component 416.

The plan 420 is used to configure a hypothetical element generation prompt 422. For example, the plan 420 can be merged or combined with a hypothetical element generation prompt template that includes the reverse-RAG instructions as described herein to create the hypothetical element generation prompt 422. The hypothetical element generation prompt 422 contains one or more instructions to cause the generative machine learning model 426 to generate and output hypothetical elements 428, such as titles or descriptions of digital elements that could exist but might not exist in a data store, using the reverse-RAG approach. For example, the hypothetical element generation prompt 422 includes an instruction to cause the generative machine learning model 426 to use the plan 420 and the GMLM's corpus of training data (excluding the embedding store 438) to generate hypothetical elements 428 and align the hypothetical elements 428 with corresponding sections of the plan 420. For instance, if the plan 420 includes a list of action items such as update resume, take online course, conduct job search, etc., then the GMLM 426 may generate and output one or more hypothetical elements 428 for each of these action items, such as a link to an article about how to update a resume, a video about changing careers, and a company profile for a recruiter, and associate each of the hypothetical elements with a respective action item (e.g., update resume: article; take online course: video; conduct job search: recruiter profile).

The GMLM 426 may order the hypothetical elements 428 according to the same ordering criteria as used by the GMLM 418 for ordering the plan sections in the plan 420. The hypothetical elements 428 are not included in the plan 420. Instead, in the described example, the hypothetical elements 428 are used as input to the RAG system 436 for validation by the RAG system 436. Thus, hypothetical elements 428 may not be presented via a user interface.

In some examples, an evaluation component 424 can be applied to the hypothetical elements 428 before the hypothetical elements 428 are provided to the RAG system 436. For example, evaluation component 424 can evaluate the hypothetical elements 428 based on the degree to which they match similar combinations of plans 420 and hypothetical elements 428 that have received positive user feedback or “golden” combinations of hypothetical elements and plans that have been manually curated. If the hypothetical elements 428 do not meet or exceed the one or more applicable evaluation criteria, the hypothetical element generation prompt 422 may be further decomposed into more discrete prompts and then resubmitted to the generative machine learning model 426. This process of evaluating the hypothetical elements 428 and modifying the hypothetical element generation prompt 422 can be repeated iteratively until the applicable evaluation criteria are met or exceeded. As such, the dotted-line and dot-dash lines in FIG. 4 indicate that there may be one or multiple hypothetical element generation prompts 422 and/or zero or more iterations of the evaluation component 424.

The hypothetical elements 428 are provide to RAG system 436 for validation. The RAG system 436 uses an embedding-based retrieval approach to generate an embedding of each hypothetical element 428 and search embedding store 438 for an embedding of a digital element that matches the embedding of the hypothetical element 428. If the RAG system 436 identifies an embedding in the embedding store 438 that meets or exceeds the one or more applicable matching criteria with respect to a given hypothetical element 320, then the digital element represented by the matching embedding retrieved from the embedding store 438 is included in the plan, e.g., the plan populated with RAG output 442. In other words, the hypothetical elements 428 can act as placeholders until they are validated through the RAG on output process, and if they are validated by the RAG on output process, then the digital elements that match the hypothetical elements are included in the plan 442 in place of the hypothetical elements. If the hypothetical elements are not validated via the described approach, they do not have any matching digital elements in the embedding store 438 and thus are not included in the plan 442.

In some examples, an evaluation component 440 can be applied to one or more portions of the plan populated with RAG output 442, before the plan 442 is provided to the requesting system, user interface, or device. For example, evaluation component 440 can evaluate one or more portions of the plan 442 based on the degree to which they match similar plans populated with RAG output 442 that have received positive user feedback or “golden” plans that have been manually curated by subject matter experts. If the plan 442 does not meet or exceed the one or more applicable evaluation criteria, the plan 442 may not be presented to the user and instead, the user may be requested to provide additional information to clarify the intent classification 412, or the intent classification prompt 406 may be further decomposed into more discrete prompts and then resubmitted to the classification machine learning model 410, or the plan generation prompt 414 may be further decomposed into more discrete prompts and then resubmitted to the generative machine learning model 418, or the hypothetical element generation prompt 422 may be further decomposed into more discrete prompts and then resubmitted to the generative machine learning model 426, or the embedding store 438 may be updated or refreshed to include embeddings of additional digital elements. This process of evaluating the GMLM outputs and modifying the prompts or updating the embedding store can be repeated iteratively until the applicable evaluation criteria are met or exceeded. While the examples describe decomposing prompts into more discrete prompts to improve the resulting GMLM output, alternatively, prompts can be consolidated or expanded rather than decomposed, to achieve the applicable evaluation criteria.

In some examples, the approaches described are used by an online learning system to generate personalized learning plans tailored to help learners achieve specific goals, like career advancement, transitioning to a new role, maintaining expertise in their field, etc. These plans include actionable content items retrieved from one or more content libraries in a structured, goal-oriented manner.

Prior approaches are heavily dependent on the use of standardized skills and the learner's knowledge of the skills required to reach their goal. To address these shortcomings of prior systems, the described approaches leverage the natural language processing capabilities of GMLMs to guide the learner with more personalized and potentially more granular recommendations. The described approaches induce AI hallucination in the GMLMs to generate plan sections, such as milestones that can be accomplished to bridge the gap between learner's current knowledge and the desired goal.

When a learner, seeking to achieve a goal, asks the online learning system to generate a learning plan, the example system will use the described approaches to, with the learner's consent, create the learner's career context using, e.g., their current role, experience and organization data based on the learner's online profile and history of data sharing activities. With the knowledge of learner's career context and requested goal, the example system causes the GMLM to generate one or more learning plans. The GMLM processes the user's context and goal to infer some possible growth paths towards the desired goal, and then generates one or more learning plans.

Example online learning systems can execute the method 400 to perform the following process: contextual input gathering, automated path generation, milestone-based learning plan generation, and content matching and plan enhancement. Contextual input gathering classifies the learner's career context information into a standardized career stage category (e.g., exploration, advancement, maintenance, etc.), a standardized career type (e.g., creative, service/support, military, etc.) and a standardized career intent. Collectively, these classifications may be referred to as the learner's current career state.

Automated path generation uses the current career state to recommend activities specifically suited to advancing toward the desired goal. These activities can be used to further inform the structure and direction of the learning plan. Collectively, these activities may be referred to as a learning plan direction.

Milestone-based learning plan uses the learning plan direction and the GMLM to create a structured plan that groups similar activities together with associated milestones. The described reverse-RAG approach may be used to, for each milestone, cause the GMLM to generate and output titles and/or descriptions of hypothetical online courses and/or other digital content that could reasonably assist a learner in achieving the goals if those titles existed in the one or more available content libraries. The information for these hypothetical content items (e.g., title and description) is hallucinated by the GMLM in that the GMLM is not provided with access to the one or more available content libraries that might contain such content items. This approach differs from the conventional RAG on input approach which relies on the context (e.g., the knowledge of the available content libraries) being fed to the GMLM as part of the input.

Content matching and plan enhancement occurs after the hypothetical elements are generated by the GMLM using AI hallucination. Post-generation, the hypothetical elements (e.g., course titles and/or content descriptions) are matched against actual content items (e.g., online courses available via a course library) using EBR (embedding-based retrieval) and an embedding store. Because the hypothetical elements were generated by the GMLM with the user's specific goals and career information in the input, the relevance of the actual courses is likely to be greater than what the prior standard search functionalities are able to provide.

While prior GMLM use cases have been centered around RAG-based search to augment the input to the GMLM, the described approaches differ in that they leverage the GMLM's generation capabilities using its existing (e.g., commercial or off the shelf) pre-training to generate output that is validated using the described reverse RAG approach. The approach is “reverse-RAG” in that content items are retrieved by applying EBR to the GMLM output, rather than using EBR to find content to be included in the input to the GMLM. For example, the GMLM is tasked with generating a plan based on a specific intent and career context but the GMLM is not provided with any information about the content that is actually available to be included in the plan. The GMLM can use its “worldly knowledge” (i.e., the corpus of training data used to create the GMLM) to interpret the career context and intent and generate the draft plan including the hypothetical elements. Then, the hypothetical elements generated and output by the GMLM are matched to actual digital content using an EBR store.

Technical benefits of the described approaches include: little-to-no manual intervention is required for curating content recommendations for reaching desired goals, even while the system remains adaptable to domain-specific customizations; the need for manually curating skills required for roles is removed; use of EBR improves search relevance and accuracy by leveraging real content with a high embedding similarity to the GMLM-generated content and removing the need to address problematic tagging patterns; as a result, learners don't need prior knowledge of the skills necessary to construct an appropriate request or query.

The examples shown in FIG. 4 and the accompanying description, above are provided for illustration purposes. This disclosure is not limited to the described examples. Additional or alternative details and implementations are described herein.

FIG. 5 is an example method of a knowledge map in accordance with some embodiments of the present disclosure.

In some examples, a knowledge map is used to direct a GMLM during its processing of input. For example, in the example of an online learning system where a user's intent relates to career development, and given the user's current career context, a knowledge map can identify to the GMLM certain types of activities that might be relevant and important to the user's intent and current career context vs. other intents and career contexts. The knowledge map can provide the GMLM with one or more constraints on relationships between different types of data, e.g., relationships between goals and activities that support those goals.

Portions of the knowledge map can be selectively provided as input to the GMLM, depending upon the current task. For example, a first portion of the knowledge map may be provided to the GMLM for the intent classification task, a second portion of the knowledge map may be provided to the GMLM for the plan generation task, and a third portion of the knowledge map may be provided to the GMLM for the hypothetical element generation task.

The knowledge map can be provided to the GMLM as a configuration file rather than as data included in the prompt. For example, the knowledge map can be included in a configuration file by codifying the relational mappings between data so that the encoded version of the mappings can be parsed and traversed programmatically. Providing the knowledge map as a configuration file can provide better control over how the GMLM interprets the knowledge map. For example, when all of the information in the knowledge map is included in a GMLM prompt, it is more difficult to control how the GMLM will assign weight values to the different pieces of information in the knowledge map. Portions of the knowledge map can be manually curated or generated dynamically based on historical data. The knowledge map can be dynamically updated based on feedback.

In the example of FIG. 5, a knowledge map 500a includes blocks and lines or edges connecting the blocks. Each block represents a different type of data identified to the knowledge map 500a, and each line or edge represents at least one type of relationship between blocks. For instance, the knowledge map 500a includes entity attribute data 502, entity activity data 504, and intent classification 506. In some examples, the other elements of FIG. 5, shown in section 500b (e.g., the plan type 508, one or more plan sections 510, one or more plan elements 512, and one or more constraints 514), may not be part of the knowledge map but may be generated by a GMLM 516 in response to input of the knowledge map 500a including elements 502, 504, 506 to the GMLM. In those examples, the knowledge map 500a may include entity attribute data 502, entity activity data 504, and intent classification 506, the associated relationships/edges, and/or other information, but may not include the mappings to plan types 508, plan sections 510, plan elements 512, and constraints 514 as those mappings may be generated and output by the GMLM using the GMLM's automated reasoning. For instance, the knowledge map 500a including entity attribute data 502, entity activity data 504, and intent classification 506, and the associated relationship data may be stored, for example, in a config file, or provided as part of a GMLM prompt, and the GMLM 516 may generate and output the mappings to plan types 508, plan sections 510, plan elements 512, and constraints 514 in response to input of the knowledge map to the GMLM 516.

The entity attribute data 502 can include, for example, attributes obtained from one or more entity profiles, such as job titles, skills, work experience, etc. The entity activity data 504 can include, with the user's content, information about the user's online data sharing activities, such as topics of articles that have been viewed, job search history, etc.

The intent classification 506 can include, for example, standardized labels corresponding to user intents, such as job search, switch career, get promoted, etc. The relationships between entity attribute data 502 and intent classification 506, and/or the relationships between entity activity data 504 and intent classification 506, specified in the knowledge map 500, can be used to guide or constrain the GMLM in interpreting its input, e.g., in determining intent classifications for input that the GMLM receives.

The plan type 508 can identify categories or types of plans. For example, a plan type for job search may be different than a plan type for get promoted. Also or alternatively, different plan types can be associated with different domains. For example, a plan to get promoted in the software industry might be different than a plan to get promoted in a law firm. The relationships between intent classifications 506 and plan types 508, specified in the knowledge map 500, can be used to guide or constrain the GMLM in interpreting its input, e.g., in identifying the different types of plans that are associated with different intent classifications.

A plan of a given plan type 508 may have one or more plan sections 510. Each plan section 510 may have one or more plan elements 512 and one or more constraints 514. Examples of plan sections 510 include steps or sub-tasks in a multi-step or multi-task plan, such as actions or milestones. Examples of plan elements include actionable digital elements associated with plan sections 510, such as digital content items identified using the described reverse-RAG approaches. For instance, a plan section 510 could include the task of updating the user's resume and that plan section could include a plan element 512 that is an article about the best way to update a resume or a connection recommendation to a resume writing consultant.

Examples of constraints 514 include rules, weights, or priorities associated with plan sections 510 and/or plan elements 512. For example, constraints 514 can specify an order of presentation for the plan sections 510 or an order of execution for the plan elements 512. The order specified by the constraint 514 can be chronological (e.g., based on the availability of the plan elements 512 or the estimated time to completion) or logical (e.g., the output of one plan section 510 is needed as an input to a different plan section).

The plan structure, including the relationships between plan types 506, plan sections 510, plan elements 512, and constraints 514, can be generated by the GMLM 516 in response to the knowledge map 500a and used by the GMLM 516 to guide or constrain the GMLM in generating plans, plan sections, and/or hypothetical elements. For example, portions of the knowledge map 500a can be provided to the GMLM in or in connection with intent classification prompt 406, plan generation prompt 414, and/or hypothetical element generation prompt 422, described with reference to FIG. 4, and the GMLM 516 may use the knowledge map 500a or portions thereof to determine the plan structure 500b and use the plan structure to generate and output plans, plan sections, and/or hypothetical elements.

In some examples, the knowledge map 500a is used to define some high level guiding principles for the GMLM 516 as to how to reason about the creation of learning plans for users. For example, the knowledge map 500a may identify a set of standardized career stages, such as: exploratory, an entry-level phase characterized by exploration, skill acquisition, and role experimentation; establishment, a mid-career phase marked by specialization, skill refinement, and professional stability; expertise, an advanced stage focusing on mastery, leadership, and strategic impact within a domain; transition, a period of career change, encompassing shifts in industry, role, or skill focus.

The knowledge map 500a may identify a set of standardized career types, such as: technical, roles primarily focused on technical expertise, such as engineering, programming, or scientific research; managerial, positions involving team or project management, leadership, and organizational oversight; creative, careers centered around artistic expression, design, content creation, or innovation; entrepreneurial, pursuits involving business ownership, startup ventures, or self-employment.

In operation, the knowledge map can be used to cause the GMLM to determine that, for example, skill assessment is a useful tool for someone in an explorative career stage, whereas professionals in the advancement stage will benefit from career planning and leadership guidance.

Portions of the knowledge map 500a can be used to determine the number of GMLM queries that are needed to achieve the user's goal or intent. For example, the knowledge map 500a can be used to identify the different steps to be performed by the GMLM and therefore the number of different calls to the GMLM (which may be implemented using, e.g., a LANGCHAIN structure).

Portions of the knowledge map 500a can be used to determine which portions of the plan generation process are to be performed by the GMLM and which portion are to be performed by one or more other models, tools, or resources. For example, constraints 514 can specify a precedence structure for determining whether to use the GMLM or some other resource, model or tool, where the determination may be made based on the availability of datasets, local configuration parameters, the cost of an API call, etc.

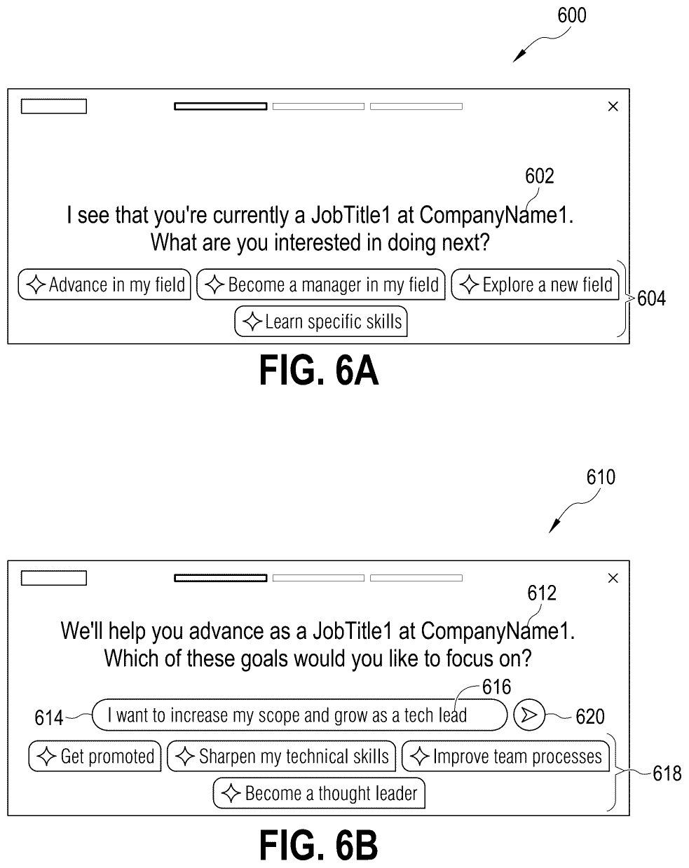

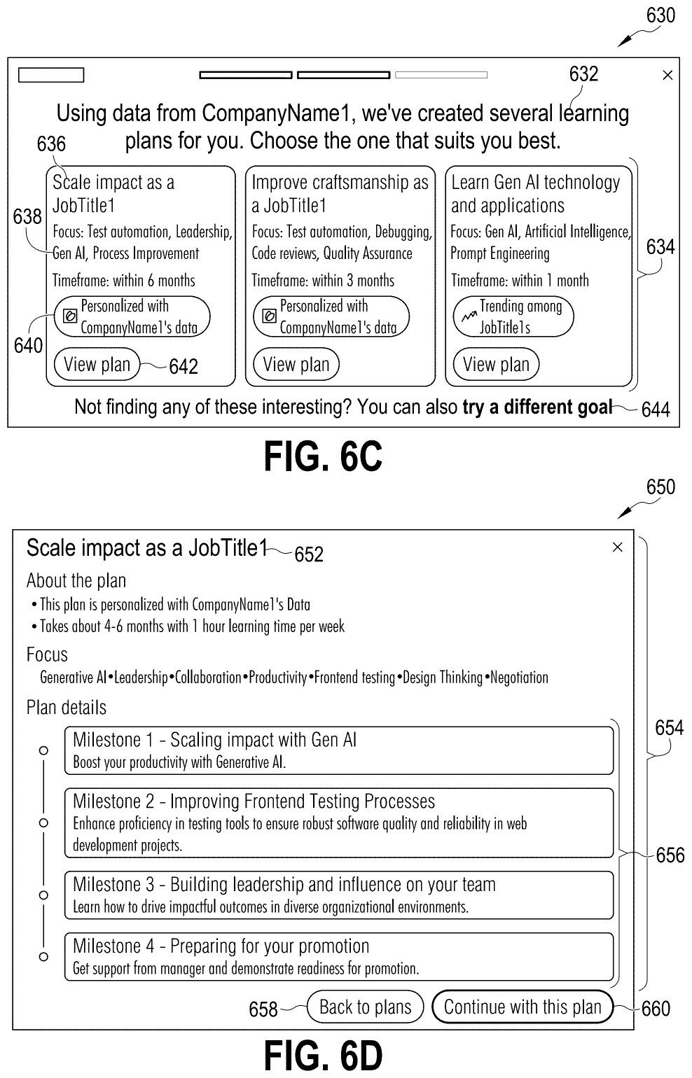

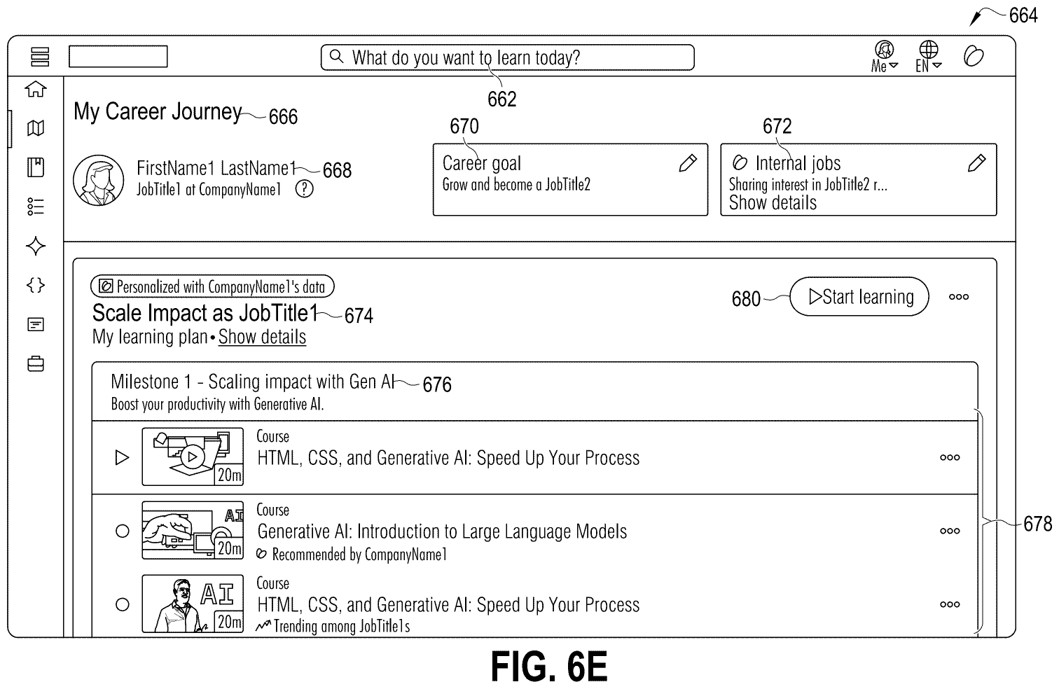

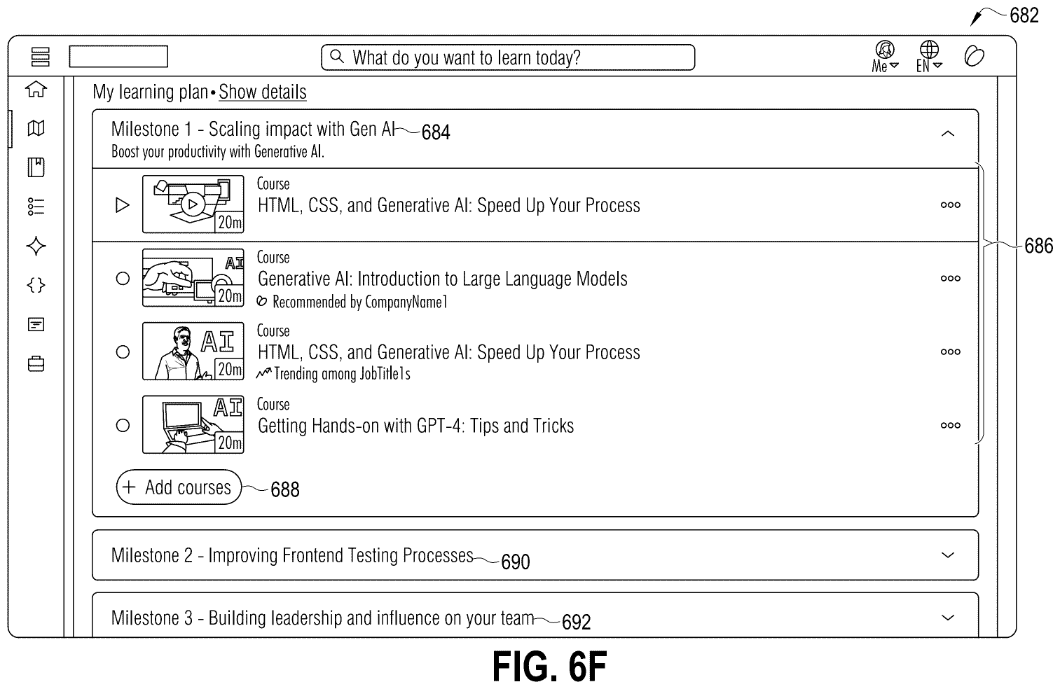

FIG. 6A, FIG. 6B, FIG. 6C, FIG. 6D, FIG. 6E, and FIG. 6F are screen captures of an example user interface flow of a computing system in accordance with some embodiments of the present disclosure.

In the user interface elements shown in FIG. 6A, FIG. 6B, FIG. 6C, FIG. 6D, FIG. 6E, and FIG. 6F, certain data that would normally be displayed may be anonymized for the purpose of this disclosure. In a live example, the actual data and not the anonymized version of the data would be displayed. For instance, the text “CompanyName” would be replaced with a name of an actual company and “FirstName LastName” would be replaced with a user's actual name.

The user interface elements shown in FIG. 6A, FIG. 6B, FIG. 6C, FIG. 6D, FIG. 6E, and FIG. 6F are presented to a user by an application system, such as a conversational agent. In some implementations, portions of the user interface elements are implemented as one or more web pages that are stored, e.g., at a user device, a server or in a cache of a user device, and then loaded into a display of a user device via the user device sending a page load request to the server or fetching data from the cache.

The graphical user interface control elements (e.g., fields, boxes, buttons, etc.) shown in the screen captures are implemented via software used to construct the user interface screens. While the screen captures illustrate examples of user interface components, e.g., visual displays, buttons, input boxes, etc., this disclosure is not limited to the illustrated embodiments, or to visual displays, or to graphical user interfaces.

In FIG. 6A, FIG. 6B, FIG. 6C, FIG. 6D, FIG. 6E, and FIG. 6F, a user interface of an application system presents an interactive dialog with a user that results in the generation of a plan and populating the plan sections with digital elements retrieved using the described reverse-RAG approaches.

In FIG. 6A, a user interface 600 initiates a dialog with a user. In the dialog, the user interface 600 presents information about the user's current position, which has been obtained from the user's online profile, e.g., JobTitle1 and CompanyName1 602. The user interface 600 also presents selectable elements 604. Each selectable element corresponds to a goal or objective. In the example application, the selectable goals or objectives relate to career planning, e.g., advance in my field, become a manager in my field, explore a new field, learn specific skills. The application system can apply the intent classification techniques described herein to the user's profile information (e.g., job title and company name) and then select the selectable elements 604 for presentation based on the user's intent. For example, the selectable elements 604 that are presented to the user in this instance may be different from selectable elements presented to the same user or other users in other instances.

In FIG. 6B, it is apparent that the user selected the advance in my field selectable element 604. As such, a user interface 610 presents a summary of the user's goal and current context, e.g., we'll help you advance, and displays the job title and company name information from the user's current position in their online profile. The user interface 610 requests additional information from the user, e.g., to more specifically refine the user's goal. The user interface 610 can be omitted from the dialog flow if after the user interface 600 the application system determines that it already has sufficient information to continue with plan generation.

In FIG. 6B, the user interface presents several options for the user to clarify the current goal, including selectable elements 618 and text input box 614. Each selectable element 618 corresponds to a subgoal of the goal identified in user interface 600. The application system can determine the subgoals to display using, e.g., intent classification including a knowledge map which may specify relationships between goals and subgoals.

In the user interface 610, the user has provided input 616 at text input box 614. The user input includes, I want to increase my scope and grow as a tech lead. A selectable element 620, if selected by the user, causes the user input 616 to be provided to the application system.

In FIG. 6C, a user interface 630 presents multiple different horizontally scrollable plan options 634 from which the user may select a plan to continue. The application system generates each of the plan options using, e.g., the plan generation, hypothetical element generation, and reverse-RAG techniques described herein. In the example of FIG. 6C, the application system has queried the entity profile data for the user's current company (e.g., CompanyName1), and, using the information about the company, the user, and the user's current goal and subgoal, generates and outputs the plan options, e.g., scale impact, improve craftsmanship, learn Gen AI technology and applications.

Each of the plan options includes a plan title and summary description (e.g., plan title 636 and description 638), as well as a notification 640 indicating that the plan has been customized with specific information about the user's company. To generate these customizations, the application system can use the described reverse-RAG techniques to obtain digital elements (e.g., pieces of content about the company) and map them to corresponding sections of the plan. The user can select one of the system-generated plan options 634 or opt to revise the user's goal by selecting option 644.

In FIG. 6D, it is apparent that the user has selected the first plan option, scale impact 636, in user interface 630. A user interface 650 presents the scale impact plan 653 in a horizontally scrollable format. The plan is customized with information about the user, e.g., job title 652, and information about the user's current company. The plan includes multiple plan sections 646. The plan sections are generated using the plan generation approaches described herein. The user interface 650 requests user feedback, e.g., to go back to the plan options by selecting element 658 or continue with the displayed plan 654 by selecting element 660.

In FIG. 6E, it is apparent that the user has selected the element 660 in user interface 650. A user interface 664 presents the selected plan 674 related to scaling impact, in more detail. The user interface 664 also includes a search bar 662 and a summary 666 of the dialog process so far. The summary 666 includes the user's profile information 668, the user's goal 670, and the user's recent online activity 672.

The user interface 664 presents the first plan section, e.g., milestone 676, boost your productivity with Generative AI. The plan 674 can include multiple plan sections, e.g., milestones, which may be presented in chronological or logical order, for example. The plan sections including the milestone 676 are generated using the plan generation techniques described herein. Underneath the milestone 676, the user interface 664 presents a scrollable list of digital elements relevant to the milestone 676. The digital elements in the list 678 are actual elements that are available for consumption by the user via, e.g., a content library. These digital elements are identified and linked with the milestone 676 using the hypothetical element generation and reverse-RAG techniques described herein. For example, given the plan title and plan section information, a GMLM generates hypothetical content descriptions and those hypothetical content descriptions that are the output of the GMLM are feed into a RAG on output process that matches them to the actual digital elements. Digital elements are only included in the list 678 if they match a hypothetical element generated by the GMLM according to the applicable matching criteria. However, the hypothetical elements generated by the GMLM themselves are only used for content retrieval purposes and are not included in the plan 674, the plan section 676, or the list of digital elements 678. The user interface 664 also includes a selectable element 680, which, if selected by the user, initiates execution and tracking of the status of the plan.

In FIG. 6F, a user interface 682 shows a different view of the plan presented in FIG. 6E. In the user interface 682, the plan includes a first plan section 684 and associated digital elements 686. The digital elements include, for example, online learning courses that are relevant to the plan section or milestone 684. The digital elements 686 are identified and retrieved using the described hypothetical element generation and reverse-RAG approaches. The user interface 682 also shows additional plan sections 690, 692. The application system determines the plan sections and organizes the plan sections 684, 690, 692 in a particular order using the plan generation techniques and potentially by obtaining ordering information from a knowledge map as described.

The examples shown in FIG. 6A, FIG. 6B, FIG. 6C, FIG. 6D, FIG. 6E, and FIG. 6F and the accompanying description are provided for illustration purposes. For example, while the examples may be illustrated as user interface screens for a smaller form factor such as smart phones, tablet computers, or wearable devices, the user interfaces can be configured for other forms of electronic devices, such as desktop computers and/or laptop devices, or vice versa. This disclosure is not limited to the described examples. Additional or alternative details and implementations are described herein.

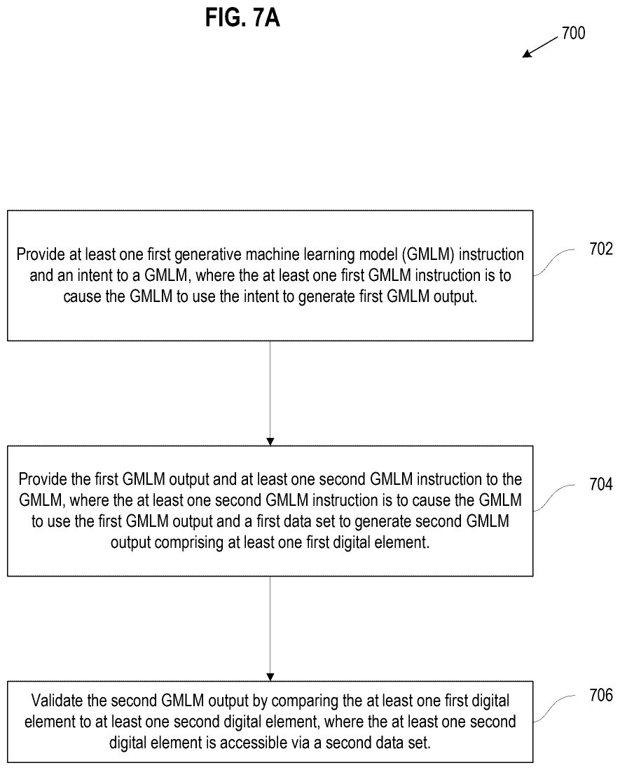

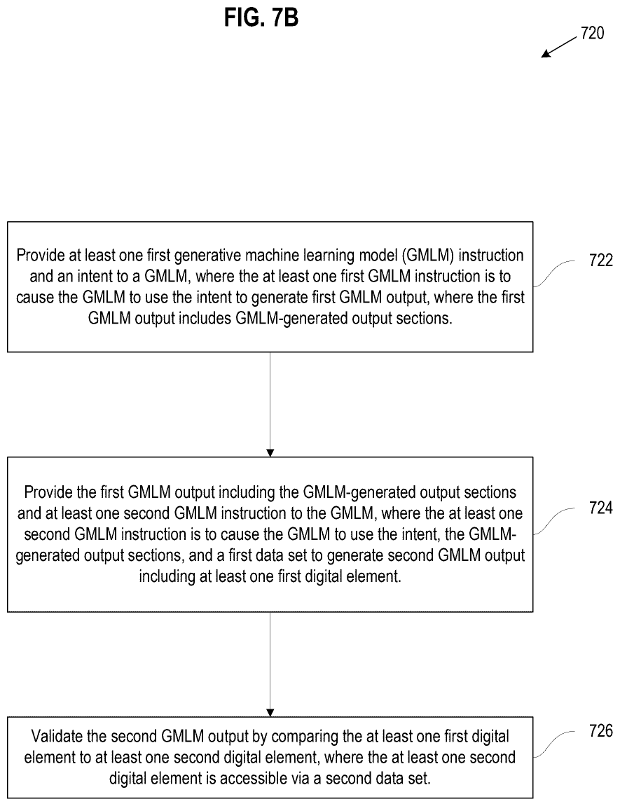

FIG. 7A and FIG. 7B are flow diagrams of example methods for digital content retrieval in accordance with some embodiments of the present disclosure.

FIG. 7A is a flow diagram of an example method for digital content retrieval in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of an application system, including, in some embodiments, components or flows shown in FIG. 7A that may not be specifically shown in other figures and/or including, in some embodiments, components or flows shown in other figures that may not be specifically shown in FIG. 7A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible. In FIG. 7A, the example method 700 can be performed by an application system or a content retrieval system.

At operation 702, a processing device provides at least one first generative machine learning model (GMLM) instruction and an intent to a GMLM. The at least one first GMLM instruction is to cause the GMLM to use the intent to generate first GMLM output. For example, the processing device applies the GMLM to the intent and a plan generation prompt. In response to the intent and the plan generation prompt, the GMLM generates and outputs one or more plans.

At operation 704, a processing device provides the first GMLM output and at least one second GMLM instruction to the GMLM. The at least one second GMLM instruction is to cause the GMLM to use the first GMLM output and a first data set to generate second GMLM output comprising at least one first digital element. For example, the processing device applies the GMLM to the first GMLM output and a hypothetical element generation prompt. In response to the first GMLM output and the hypothetical element prompt, the GMLM uses the first data set (e.g., its corpus of training data) to generate and output one or more hypothetical elements.

At operation 706, a processing device validates the second GMLM output by comparing the at least one first digital element to at least one second digital element. The at least one second digital element is accessible via a second data set, e.g., a digital content library or embedding store. For example, the processing device uses reverse-RAG as described to match hypothetical elements to actual digital elements that are retrievable from the second data set via an embedding-based retrieval approach.

The method and each or any of the operations 702, 704, 706 can include additional or alternative operations described herein. The examples shown in FIG. 7A and the accompanying description, above are provided for illustration purposes. This disclosure is not limited to the described examples. Additional or alternative details and implementations are described herein.

FIG. 7B is a flow diagram of an example method for digital content retrieval in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of an application system, including, in some embodiments, components or flows shown in FIG. 7B that may not be specifically shown in other figures and/or including, in some embodiments, components or flows shown in other figures that may not be specifically shown in FIG. 7B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible. In FIG. 7B, the example method 720 can be performed by an application system or a content retrieval system.

At operation 722, a processing device provide at least one first generative machine learning model (GMLM) instruction and an intent to a GMLM. The at least one first GMLM instruction is to cause the GMLM to use the intent to generate first GMLM output. The first GMLM output includes GMLM-generated output sections. For example, the intent is obtained via user input, attribute and/or activity data, and/or using intent classification techniques as described. The at least one first GMLM instruction can include a plan generation prompt as described. The first GMLM output can include a plan including plan sections.

At operation 724, a processing device provides the first GMLM output including the GMLM-generated output sections and at least one second GMLM instruction to the GMLM. The at least one second GMLM instruction is to cause the GMLM to use the intent, the GMLM-generated output sections, and a first data set to generate second GMLM output including at least one first digital element. For example, the at least one second GMLM instruction includes a hypothetical element generation prompt as described. The second GMLM output, e.g., the at least one first digital element, can include at least one hypothetical element generated by the GMLM using the first data set (e.g., the corpus of data used to train the GMLM), in response to the at least one second GMLM instruction.

At operation 726, a processing device validates the second GMLM output by comparing the at least one first digital element to at least one second digital element. The at least one second digital element is accessible via a second data set, e.g., a library of digital content or embedding store. For example, the processing device uses reverse-RAG as described to match hypothetical elements to actual digital elements that are retrievable from the second data set via an embedding-based retrieval approach.

The method and each or any of the operations 722, 724, 726 can include additional or alternative operations described herein. The examples shown in FIG. 7A and the accompanying description, above are provided for illustration purposes. This disclosure is not limited to the described examples. Additional or alternative details and implementations are described herein.

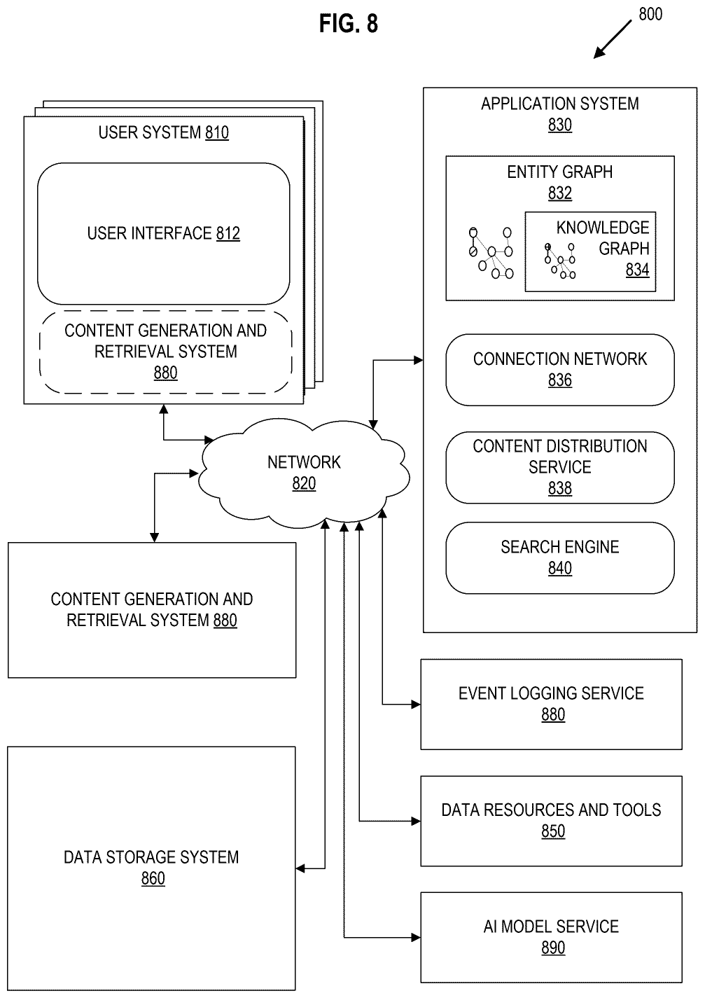

FIG. 8 is a block diagram of a computing system that includes a content retrieval system in accordance with some embodiments of the present disclosure.

In the embodiment of FIG. 8, a computing system 800 includes one or more user systems 810, a network 820, an application system 830, data resources and tools 850, a content generation and retrieval system 880, a data storage system 860, an event logging service 870, and an AI model service 890.

All or at least some components of content generation and retrieval system 880 are implemented at the user system 810, in some implementations. For example, portions of content generation and retrieval system 880 are implemented directly upon a single client device such that communications involving applications running on user system 810 and content generation and retrieval system 880 occur on-device without the need to communicate with, e.g., one or more servers, over the Internet. Dashed lines are used in FIG. 8 to indicate that all or portions of content generation and retrieval system 880 can be implemented directly on the user system 810, e.g., the user's client device. In other words, both user system 810 and content generation and retrieval system 880 can be implemented on the same computing device, in some implementations. In other implementations, all or portions of content generation and retrieval system 880 are implemented on one or more servers and in communication with user systems 810 via network 820.

A user system 810 includes at least one computing device, such as a personal computing device, a server, a mobile computing device, a wearable electronic device, or a smart appliance, and at least one software application that the at least one computing device is capable of executing, such as an operating system or a front end of an online system. Many different user systems 810 can be connected to network 820 at the same time or at different times. Different user systems 810 can contain similar components as described in connection with the illustrated user system 810. For example, many different end users of computing system 800 can be interacting with many different instances of application system 830 through their respective user systems 810, at the same time or at different times.

User system 810 includes a user interface 812. User interface 812 is installed on user system 810 or accessible to user system 810 via network 820. Embodiments of user interface 812 can include a front end portion of an application system or and/or content generation and retrieval system 880.

User interface 812 includes, for example, a graphical display screen that includes graphical user interface elements such as at least one input box or other input mechanism and at least one slot. A slot as used herein refers to a space on a graphical display such as a web page or mobile device screen, into which output, e.g., digital content such as search results, feed items, chat boxes, or threads, can be loaded for display to the user. For example, user interface 812 may be configured with a scrollable arrangement of variable-length slots that simulates an online chat or instant messaging session and/or a scrollable arrangement of slots that contain content items or search results. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, a slot may be defined using a three-dimensional coordinate system. Example screen captures of user interface screens that can be included in user interface 812 are shown in the drawings and described herein.

User interface 812 can be used to interact with the content generation and retrieval system 880 and/or one or more application systems 830. For example, user interface 812 enables the user of a user system 810 to interact with an application system to create, edit, send, view, receive, process, and organize requests, search queries, search results, content items, news feeds, and/or portions of online dialogs. In some implementations, user interface 812 enables the user to input requests (e.g., queries) for various different types of information, to initiate user interface events, and to view or otherwise perceive output such as data and/or digital content produced by, e.g., an application system 830, content generation and retrieval system 880, content distribution service 838 and/or search engine 840. For example, user interface 812 can include a graphical user interface (GUI), a conversational voice/speech interface, a virtual reality, augmented reality, or mixed reality interface, and/or a haptic interface. User interface 812 can include a mechanism for entering search queries and/or selecting search criteria (e.g., facets, filters, etc.), selecting GUI user input control elements, and interacting with digital content such as search results, entity profiles, posts, articles, feeds, and online dialogs. Examples of user interface 812 include web browsers, command line interfaces, and mobile app front ends. User interface 812 as used herein can include application programming interfaces (APIs).

Network 820 includes an electronic communications network. Network 820 can be implemented on any medium or mechanism that provides for the exchange of digital data, signals, and/or instructions between the various components of computing system 800. Examples of network 820 include, without limitation, a Local Area Network (LAN), a Wide Area Network (WAN), an Ethernet network or the Internet, or at least one terrestrial, satellite or wireless link, or a combination of any number of different networks and/or communication links.

Application system 830 can include, for example, one or more online systems that provide social network services, general-purpose search engines, specific-purpose search engines, messaging systems, content distribution platforms, e-commerce software, enterprise software, or any combination of any of the foregoing or other types of software. Application system 830 can include any type of application system that provides or enables the retrieval of and interactions with at least one form of digital content, including machine-generated content via user interface 812. In some implementations, portions of content generation and retrieval system 880 are components of application system 830. An application system 830 can include one or more of an entity graph 832 and/or knowledge graph 834, a user connection network 15315, a content distribution service 838, and/or a search engine 840. In other embodiments, application system 830 can interact with content generation and retrieval system 880 to control a physical machine or device, such as a vehicle or a robot.

In some implementations, a front end portion of application system 830 can operate in user system 810, for example as a plugin or widget in a graphical user interface of a web application, mobile software application, or as a web browser executing user interface 812. In an embodiment, a mobile app or a web browser of a user system 810 can transmit a network communication such as an HTTP request over network 820 in response to user input that is received through a user interface provided by the web application, mobile app, or web browser, such as user interface 812. A server running application system 830 can receive the input from the web application, mobile app, or browser executing user interface 812, perform at least one operation using the input, and return output to the user interface 812 using a network communication such as an HTTP response, which the web application, mobile app, or browser receives and processes at the user system 810.

In the example of FIG. 8, an application system 830 includes an entity graph 832 and/or a knowledge graph 834. Entity graph 832 and/or knowledge graph 834 include data organized according to graph-based data structures that can be traversed via queries and/or indexes to determine relationships between entities. For instance, entity graph 832 and/or knowledge graph 834 can be used to compute various types of relationship weights, affinity scores, similarity measurements, and/or statistics between, among, or relating to entities.

Entity graph 832, knowledge graph 834 includes a graph-based representation of data stored in data storage system 860, described herein. For example, entity graph 832, knowledge graph 834 represents entities, such as users, organizations (e.g., companies, schools, institutions), content items (e.g., job postings, announcements, articles, comments, and shares), and computing resources (e.g., databases, models, applications, and services), as nodes of a graph. Entity graph 832, knowledge graph 834 represents relationships, also referred to as mappings or links, between or among entities as edges, or combinations of edges, between the nodes of the graph. In some implementations, mappings between different pieces of data used by an application system 830 are represented by one or more entity graphs. In some implementations, the edges, mappings, or links indicate relationships, online interactions, or activities relating to the entities connected by the edges, mappings, or links. For example, if a user clicks on a search result, an edge may be created connecting the user entity with the search result entity in the entity graph, where the edge may be tagged with a label such as “viewed.” If a user viewing a list of search results skip over a search result without clicking on the search result, an edge may not be created between the user entity and the search result entity in the entity graph.

Portions of entity graph 832, knowledge graph 834 can be automatically re-generated or updated from time to time based on changes and updates to the stored data, e.g., updates to entity data and/or activity data. Also, entity graph 832, knowledge graph 834 can refer to an entire system-wide entity graph or to only a portion of a system-wide graph. For instance, entity graph 832, knowledge graph 834 can refer to a subset of a system-wide graph, where the subset pertains to a particular user or group of users of application system 830.

Knowledge graph 834 includes a graph-based representation of data stored in data storage system 860. Knowledge graph 834 represents relationships, also referred to as links or mappings, between entities or concepts as edges, or combinations of edges, between the nodes of the graph. In some implementations, mappings between different pieces of data used by application system 830 or across multiple different application systems are represented by the knowledge graph 834.

In some implementations, knowledge graph 834 is a subset or a superset of entity graph 832. For example, in some implementations, knowledge graph 834 includes multiple different entity graphs 832 that are joined by cross-application or cross-domain edges. For instance, knowledge graph 834 can join entity graphs 832 that have been created across multiple different databases or across different software products. In some implementations, the entity nodes of the knowledge graph 834 represent concepts, such as product surfaces, verticals, or application domains. In some implementations, knowledge graph 834 includes a platform that extracts and stores different concepts that can be used to establish links between data across multiple different software applications. Examples of concepts include topics, industries, and skills. As with other portions of entity graph 832, knowledge graph 834 can be used to compute various types of relationship weights, affinity scores, similarity measurements, and/or statistical correlations between or among entities and/or concepts.

In the example of FIG. 8, application system 830 includes a user connection network 836. User connection network 836 includes, for instance, a social network service, professional social network system and/or other social graph-based applications. Content distribution service 838 includes, for example, a feed, chatbot or chat-style system, or a messaging system, such as a peer-to-peer messaging system that enables the creation and exchange of messages between users of application system 830 and the application system 830. Search engine 840 includes a search engine that enables users of application system 830 to input and execute search queries to retrieve information from one or more sources of information, such as user connection network 836, entity graph 832, knowledge graph 834, one or more data stores of data storage system 860, or one or more data resources and tools 850.

In the example of FIG. 8, application system 830 includes a content distribution service 838. The content distribution service 838 can include a data storage service, such as a web server, which stores digital content items, and transmits digital content items to users via user interface 812. In some embodiments, content distribution service 838 processes requests from, for example, application system 830 and/or content generation and retrieval system 880, and distributes digital content items to user systems 810 in response to requests.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, an input of a search query, or a page load. In some implementations, content distribution service 838 is part of application system 830. In other implementations, content distribution service 838 interfaces with application system 830 and/or content generation and retrieval system 880, for example, via one or more application programming interfaces (APIs).

In the example of FIG. 8, application system 830 includes a search engine 840. Search engine 840 includes a software system designed to search for and retrieve information by executing queries on one or more data stores, such as databases, connection networks, and/or graphs. The queries are designed to find information that matches specified criteria, such as keywords and phrases contained in user input and/or system-generated queries. For example, search engine 840 is used to retrieve data in response to user input and/or system-generated queries, by executing queries on various data stores of data storage system 860 and/or data resources and tools 850, or by traversing entity graph 832, knowledge graph 834.

Data resources and tools 850 include computing resources, such as data stores, databases, embedding-based retrieval mechanisms, code generators, etc., that can be used to operate an agent or content retrieval system. Data resources and tools 850 can include computing resources that are internal to application system 830 or external to application system 830. Examples of data resources and tools 850 include entity graphs, knowledge graphs, indexes, databases, networks, applications, models (e.g., large language models and/or other artificial intelligence models or machine learning models), taxonomies, data services, web pages, vectors (e.g., data stores that store embeddings), and searchable digital catalogs. Each data resource or tool 850 enables an agent or content retrieval system to access the data resource or tool, for example by providing an application programming interface (API). Each data resource or tool 850 can include a monitoring service that periodically generates, publishes, or broadcasts availability and/or other performance metrics associated with the data resource. For example, a data resource or tool 850 can provide a set of APIs that can be used by an agent or content retrieval system to access the data resource or tool, obtain output from the data resource, and/or obtain performance metrics for the data resource or tool.

Data storage system 860 includes data stores and/or data services that store digital data received, used, manipulated, and produced by application system 830 and/or content generation and retrieval system 880, including contextual data, state data, prompts and/or prompt templates for generative artificial intelligence models or large language models, user inputs, system-generated outputs, metadata, attribute data, activity data. Examples of databases or data stores that can be used in embodiments include vector databases, graph databases, relational databases, and key-value stores.

In the example of FIG. 8, data storage system 860 includes various data stores that store, for example, entity data, context data, prompts, embeddings, etc. A data store can include a volatile memory such as a form of random access memory (RAM) and/or persistent memory, which can be available on user system 810 or another device (e.g., one or more servers) for storing state data generated at the user system 810 or an application system 830. As another example, in some implementations, a separate, personalized version of each or any data store is created for each user such that data is not shared between or among the separate, personalized versions of the data stores.

In some embodiments, data storage system 860 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of data storage system 860 can be configured to store data produced by real-time and/or offline (e.g., batch) data processing. A data store configured for real-time data processing can be referred to as a real-time data store. A data store configured for offline or batch data processing can be referred to as an offline data store. Data stores can be implemented using databases, such as key-value stores, relational databases, and/or graph databases. Data can be written to and read from data stores using query technologies, e.g., SQL or NoSQL.

Data storage system 860 resides on at least one persistent and/or volatile storage device that can reside within the same local network as at least one other device of computing system 800 and/or in a network that is remote relative to at least one other device of computing system 800. Thus, although depicted as being included in computing system 800, portions of data storage system 860 can be part of computing system 800 or accessed by computing system 800 over a network, such as network 820.

Event logging service 870 captures and records activity data generated during operation of application system 830 and/or content generation and retrieval system 880, including user interface events generated at user systems 810 via user interface 812, in real time, and formulates the user interface events and/or other network activity data into a data stream that can be consumed by, for example, a stream processing system. Examples of network activity data include logins, page loads, dialog inputs, input of search queries or query terms, selections of facets or filters, clicks on search results or graphical user interface control elements, scrolling lists of search results, and social action data such as likes, shares, comments, and social reactions (e.g., “insightful,” “curious,” “like,” etc.). For instance, when a user of application system 830 via a user system 810 enters input or clicks on a user interface element, such as a workflow element, or a user interface control element such as a view, comment, share, or reaction button, or uploads a file, or inputs a query, or scrolls through a feed, etc., event logging service 870 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web applications and mobile applications.

For instance, when a user enters input or reacts to system-generated output, such as a list of search results, event logging service 870 stores the corresponding event data in a log. Event logging service 870 generates a data stream that includes a record of real-time event data for each user interface event that has occurred. Event data logged by event logging service 870 can be pre-processed and anonymized as needed so that it can be used as context data to, for example, configure one or more instructions for one or more artificial intelligence models (e.g., large language models), or to modify weights, affinity scores, or similarity measurements that are assigned by the content retrieval system to search results or data resources.

Content generation and retrieval system 880 includes any one or more of the components, features, or functions described herein with respect to an application system or content retrieval system or content generation and retrieval, e.g., a system that uses a reverse-RAG approach for content retrieval, such as for plan generation and populating plans with digital elements.

AI model service 890 includes one or more artificial intelligence-based models, such as large language models and/or other types of machine learning models including discriminative and/or generative models, neural networks, probabilistic models, statistical models, transformer-based models, and/or any combination of any of the foregoing. AI model service 890 enables application systems, agents, and content retrieval systems to access to these models, for example by providing one or more application programming interfaces (APIs). AI model service 890 can include a monitoring service that periodically generates, publishes, or broadcasts latency and/or other performance metrics associated with the models. For example, AI model service 890 can provide a set of APIs that can be used by an agent or content retrieval system to obtain performance metrics for large language models and/or other machine learning models.

While not specifically shown, it should be understood that any of user system 810, application system 830, data resources and tools 850, data storage system 860, event logging service 870, content generation and retrieval system 880, and AI model service 890 includes an interface embodied as computer programming code stored in computer memory that when executed causes a computing device to enable bidirectional communication with any other of user system 810, application system 830, data resources and tools 850, data storage system 860, event logging service 870, content generation and retrieval system 880, and AI model service 890 using a communicative coupling mechanism. Examples of communicative coupling mechanisms include network interfaces, inter-process communication (IPC) interfaces and application program interfaces (APIs).

Each of user system 810, application system 830, data resources and tools 850, data storage system 860, event logging service 870, content generation and retrieval system 880, and AI model service 890 is implemented using at least one computing device that is communicatively coupled to electronic communications network 820. Any of user system 810, application system 830, data resources and tools 850, data storage system 860, event logging service 870, content generation and retrieval system 880, and AI model service 890 can be bidirectionally communicatively coupled by network 820. User system 810 as well as other different user systems (not shown) can be bidirectionally communicatively coupled to application system 830 and/or content generation and retrieval system 880.

A typical user of user system 810 can be an administrator or end user of application system 830 or content generation and retrieval system 880. User system 810 is configured to communicate bidirectionally with any of application system 830, data resources and tools 850, data storage system 860, event logging service 870, content generation and retrieval system 880, and AI model service 890 over network 820.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 810, application system 830, data resources and tools 850, data storage system 860, event logging service 870, content generation and retrieval system 880, and AI model service 890 are implemented using computer software, hardware, or software and hardware, and can include combinations of automated functionality, data structures, and digital data, which are represented schematically in the figures. User system 810, application system 830, data resources and tools 850, data storage system 860, event logging service 870, content generation and retrieval system 880, and AI model service 890 are shown as separate elements in FIG. 8 for ease of discussion but, except as otherwise described, the illustration is not meant to imply that separation of these elements is required. The illustrated systems, services, and data stores (or their functionality) of each of user system 810, application system 830, data resources and tools 850, data storage system 860, event logging service 870, content generation and retrieval system 880, and AI model service 890 can be divided over any number of physical systems, including a single physical computer system, and can communicate with each other in any appropriate manner.

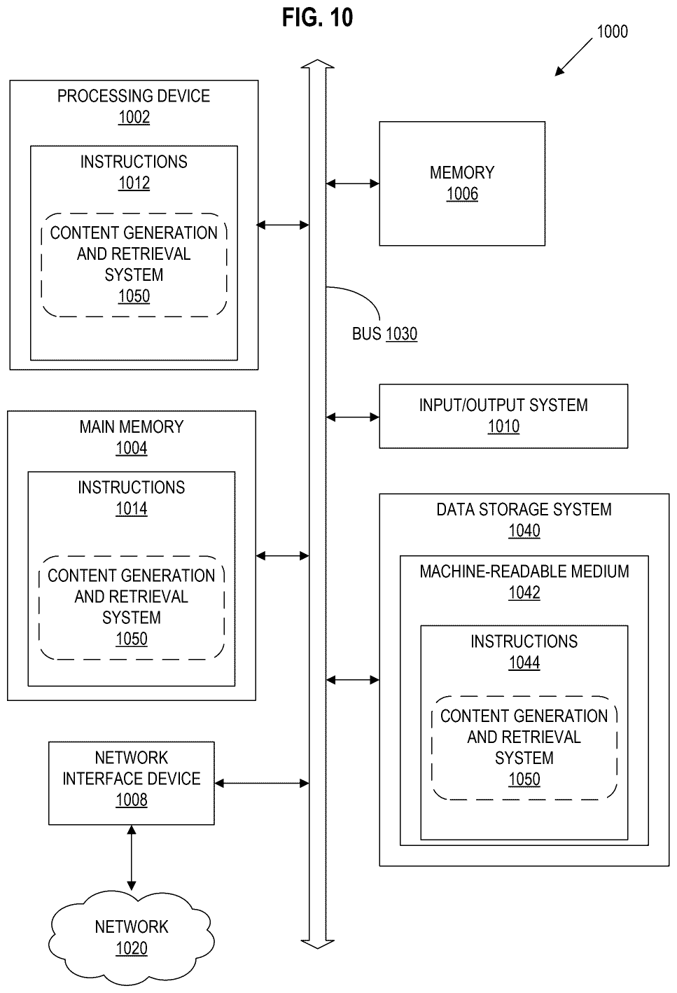

In the embodiment of FIG. 10, portions of content generation and retrieval system 880 that may be implemented on a front end system, such as one or more user systems, and portions of content generation and retrieval system 880 that may be implemented on a back end system such as one or more servers, are collectively represented as content generation and retrieval system 1050 for ease of discussion only. For example, portions of content generation and retrieval system 880 are not required to be implemented all on the same computing device, in the same memory, or loaded into the same memory at the same time. For instance, access to portions of content generation and retrieval system 880 can be limited to different, mutually exclusive sets of user systems and/or servers. For instance, in some implementations, a separate, personalized version of content generation and retrieval system 880 is created for each user of the content generation and retrieval system 880 such that data is not shared between or among the separate, personalized versions of the content generation and retrieval system 880. Additionally, certain portions of content generation and retrieval system 880 typically may be implemented on user systems while other portions of content generation and retrieval system 880 typically may be implemented on a server computer or group of servers. In some embodiments, however, one or more portions of content generation and retrieval system 880 are implemented on user systems. For example, content generation and retrieval system 880 is entirely implemented on user systems, e.g., client devices, in some implementations. For instance, a version of content generation and retrieval system 880 can be embedded in a client device's operating system or stored at the client device and loaded into memory at execution time.

The examples shown in FIG. 8 and the accompanying description, above are provided for illustration purposes. This disclosure is not limited to the described examples. Additional or alternative details and implementations are described herein.

FIG. 9A, FIG. 9B, FIG. 9C, FIG. 9D are block diagrams of examples of machine learning models that can be used by and/or included in a content retrieval system in accordance with some embodiments of the present disclosure.

FIG. 9A is a block diagram of a machine learning model that can be used by and/or included in a content retrieval system in accordance with some embodiments of the present disclosure.

Machine learning models are computer-implemented structures that are capable of generating predictive output in response to raw input. A machine learning model includes a probabilistic or statistical algorithm that is configured to perform a specific predictive function through a training process that involves iteratively exposing the models to many samples of data and adjusting one or more model parameters until the models achieve a satisfactory prediction accuracy and reliability. The predictive accuracy and reliability of a machine learning model in relation to a particular task is dependent upon the training process and the data used in the training.

Machine learning systems include components and processes that perform data generation, model training, model evaluation (e.g., calibration and validation), and application. Data preparation includes obtaining and aggregating model input data. The preparation of training data can include labeling the aggregated data. Training data can include structured data, unstructured data, text, multimodal data, or any combination of any of the foregoing. Model training can include configuring hyperparameters, determining performance metrics, and applying the machine learning model to the training data, evaluating the performance metrics, and parameter tuning. Application includes applying the trained machine learning model to the real-world environment, e.g., in a specific use case using data not included in the training data (e.g., unlabeled data). The application phase can be referred to as inferencing or inference time.

In FIG. 9A, a machine learning modeling system 900 includes a machine learning model 906, a modeling and calibration subsystem 902, and a model validation subsystem 904. The machine learning model 906 can be or include any type or combination of one or more machine learning models, such as any of the types of machine learning models shown in FIG. 9B, FIG. 9C, FIG. 9D, and FIG. 9E and/or any other types or combinations of machine learning models.

The modeling and calibration subsystem 902 receives model input, such as input feature sets, embeddings, digital content, or prompts. The model input can be engineered to train the machine learning model 906 to perform one or more tasks, such as discriminative tasks like classification or scoring and/or generative tasks such as content generation tasks. Modeling and calibration subsystem 902 includes a data set creation component 903, a model training component 905, and a model calibration component 907.

Data set creation component 903 can divide the model input, e.g., input feature sets, into one or more training data sets and one or more validation data sets, e.g., training data set 909 and validation data set 911. Model training component 905 and model calibration component 907 cooperatively execute a training process. In some embodiments, the training process causes the machine learning model 906 to develop, by iterative adjustments to weights or coefficients, a mathematical representation of the relationships between different items of data, such as relationships between different inputs (e.g., similarity estimates or estimates of user preferences), or relationships between inputs and categorical data such as classification labels, or relationships between inputs and outputs. The resulting trained model can be used to generate predictive output (e.g., scores, labels, or other output) based on subsequent model input.

One or more different approaches can be used to train the machine learning model 906, for example, supervised machine learning, semi-supervised machine learning, or unsupervised machine learning. In supervised machine learning, the set of training data includes indications of expected model output coupled with respective model input; for example, ground-truth labeled data samples. For example, an instance of training data for supervised learning can include a model input (e.g., a set of features) and an associated expected output (e.g., a classification label), where the expected output can be human curated or machine-generated. For example, an instance of training data for supervised machine learning can include a digital image and a title or caption for the image that describes the contents of the image. In unsupervised machine learning, the training examples are unlabeled. In unsupervised machine learning, a clustering algorithm can be used to identify similarities among data samples and create clusters or groupings of similar data using one or more similarity criteria. For example, unsupervised learning can be used to group digital content items, such as images, articles, or videos, into topics, where the topics are determined based on the features of the content items themselves rather than supplied by labels. Semi-supervised machine learning combines supervised and unsupervised machine learning, using both labeled and unlabeled data to train machine learning models.

Model training component 905 applies machine learning model 906 to training data set 909 iteratively and adjusts the value of one or more model parameters and/or feature coefficients of the machine learning model 906 based on the processing of the training data set 909 by the model 906 until the difference between the predicted model output generated by the machine learning model 906 and the expected model output evidenced by the training data set 909 satisfies (e.g., meets or exceeds) model performance criteria 908. When the model performance criteria 908 are satisfied, modeling and calibration subsystem 902 ends the model training process and produces a trained machine learning model 906.

Model validation subsystem 904 applies a model validation process to the trained machine learning model 906 produced by modeling and calibration subsystem 902. Model validation subsystem 904 uses the validation data set 911 to determine whether model validation criteria 910 are satisfied (e.g., met or exceeded). For example, the validation data set 911 can be created by setting aside a portion of the training data set 909 until after training, such that the validation data set 911 can be used to compare and evaluate the difference between the predictive output produced by the trained model to the expected model output evidenced by the set-aside portion of the training data set 909.

A validated machine learning model 906 can be used for inferencing, e.g., to generate predictive output, e.g., labels, scores, or other content, in response to model input. Alternatively or in addition, the output produced by the validated machine learning model 906 can be stored for future use (e.g., for access or lookup by one or more downstream processes, systems, or services).

There are many different types and configurations of machine learning models. Illustrative, nonlimiting examples of some of the different types of machine learning models are shown in FIG. 9B, FIG. 9C, FIG. 9D, and FIG. 9E, described below. The Als, models, and AI model services described herein can include or use any of the various types of machine learning models, including but not limited to one or more of the types of models shown in FIG. 9B, FIG. 9C, FIG. 9D, and FIG. 9E.

The examples shown in FIG. 9A and the accompanying description, above are provided for illustration purposes. This disclosure is not limited to the described examples. Additional or alternative details and implementations are described herein.

FIG. 9B is a block diagram of a machine learning model that can be used by and/or included in a content retrieval system in accordance with some embodiments of the present disclosure.

In the example of FIG. 9B, a machine learning system 912 includes a machine learning model 915. Machine learning model 915 is or includes a probabilistic or statistical machine learning model that uses a modeling function 916 to model the relationship between model input 914 (e.g., input feature set X) and model output (e.g., Y, P(Y|X)).

In some embodiments, the machine learning model 915 is configured as a discriminative model such that the machine learning model 915 produces output that indicates the probabilistic or statistical likelihood of an output Y given an input X. Some embodiments of the machine learning model 915 can be alternatively or additionally configured as a generative model. For example, in some embodiments, a machine learning model can perform both discriminative and generative tasks.

One illustrative example of a discriminative model is a logistic regression function. Mathematically, a simplified form of the logistic function can be expressed as P(X)=f(x)=1/1+e^{-(β}^{₀}^{+β}^{₁}^{x)}, where e is the exponential constant and β₀ and β₁ are feature coefficients. During training of the logistic regression model 915, logistic regression estimates the values of the coefficients in the linear combination based on the feature values in the training data set. The machine learning model 915 can be configured via training, calibration, and validation processes such as those described with reference to FIG. 9A.

The machine learning model 915 includes a modeling function 916. The modeling function 916 includes feature coefficients 917. The values of one or more of the feature coefficients 917 can be established via machine learning model training, calibration, and validation processes based on training data sets and/or validation data sets.

In the logistic regression example, the feature coefficients 917 can include a regression coefficient β for each feature input x (e.g., f(i)=β₀+β₁x_{1,i}+ . . . βₘx_{m,i}), where xᵢ is a particular item of the feature set and m is the number of feature inputs x in the input feature set X 914. The regression coefficient indicates the relative effect of the particular feature input x of the feature set X on the predicted outcome P(Y|X), e.g., a predicted label or score, based on the values of the feature inputs x in the feature set X 914. The values of the feature coefficients are initialized and adjusted during model training and calibration.

The machine learning model 915 also includes model hyperparameters 918. The values of hyperparameters 918 are selected or tuned at a global level and generally are not modified based on specific instances of training data. In the logistic regression example, model hyperparameters 918 can include a penalty or regularization parameter (e.g., L1 or L2) and the C or regularization strength parameter. The penalty or regularization parameter is tunable to adjust model generalization error and regulate overfitting. The C or regularization strength parameter regulates overfitting in conjunction with the penalty. The model hyperparameters 918 can be tuned using, for example, a hyperparameter tuning tool or hyperparameter optimization method.

Some embodiments of the machine learning model 915 can be configured as a binary classifier or as a scoring model. In a binary classification mode, the output of the machine learning model 915 indicates whether the model input is or is not associated with a certain output (e.g., either 0 if the input is not mathematically likely to be associated with the output or 1 if the input is mathematically likely to be associated with the output), for a given set of input features. In a scoring mode, the output of the machine learning model 915 includes a score, which corresponds to a probability of the predicted output (e.g., a numerical value between zero and 1, inclusive).

The model input 914 (e.g., input feature set X) can include numerical features, categorical features, quantitative values, qualitative values, raw features, compressed representations of raw features (e.g., vector representations or embeddings, and/or other forms of digital content.

In response to an instance of features of feature set X, machine learning model 915 computes and outputs an estimated output P(Y|X) 919. The estimated output produced by machine learning model 915 based on an instance of features of feature set X 914 can be in the form of a binary output or a score. The output can be stored in a data storage for subsequent lookup or provided to one or more downstream systems, processes, devices, frameworks, and/or services.

The machine learning model 915 can be configured and implemented as a network service. For example, the machine learning model 915 can be configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the machine learning model 915 and/or its output can be hosted on one or more servers and/or data storage devices for accessibility to one or more requesting processes, systems, devices, frameworks, or services.

The examples shown in FIG. 9B and the accompanying description, above are provided for illustration purposes. This disclosure is not limited to the described examples. Additional or alternative details and implementations are described herein.

FIG. 9C is a block diagram of a machine learning model that can be used by and/or included in a content retrieval system in accordance with some embodiments of the present disclosure.

A generative artificial intelligence (GAI) model or generative model uses artificial intelligence technology, e.g., machine learning, neural networks, to machine-generate digital content based on model inputs and the previously existing data with which the model has been trained. Whereas discriminative models are based on conditional probabilities P(y|x), that is, the probability of an output y given an input x, generative models capture joint probabilities P(x, y), that is, the likelihood of x and y occurring together. A generative language model is a particular type of GAI model that is capable of generating content in response to model input. The model input includes a task description, also referred to as a prompt. The task description can include instructions (e.g., natural language instructions such as “please generate a summary of these search results”) and/or examples of digital content (e.g., examples of summaries written using a particular writing style or tone). Portions of the task description can be in the form of natural language text, such as a question or a statement. Alternatively or in addition, a task description or prompt can include non-text forms of content, such as digital imagery and/or digital audio.

In the example of FIG. 9C, a machine learning system 920 includes a machine learning model 924. Machine learning model 924 is or includes a probabilistic or statistical machine learning model that uses a modeling function to model the likelihood of cooccurrence of input feature set X and output Y; e.g., the likelihood of X and Y occurring together. The machine learning model 924 can be configured via training, calibration, and validation processes such as those described with reference to FIG. 9A. Some embodiments of the machine learning model 924 can be alternatively or additionally configured as a discriminative model. For example, in some embodiments, a machine learning model can perform both discriminative and generative tasks.

The machine learning model 924 includes a modeling function 925. The modeling function 925 includes feature coefficients or weights 926. The values of one or more of the feature coefficients can be established via machine learning model training, calibration, and validation processes based on training data sets and/or validation data sets. The machine learning model 924 also includes model hyperparameters 927. The values of model hyperparameters 927 are selected or tuned at a global level and generally are not modified based on specific instances of training data.

The model input 922 (e.g., input feature set X) can include numerical features, categorical features, quantitative values, qualitative values, raw features, compressed representations of raw features (e.g., vector representations or embeddings), and/or other forms of digital content.

In response to an instance of model input 922 (e.g., instance of feature set X), machine learning model 924 computes and outputs an estimated output P(X,Y) 928. The estimated output produced by machine learning model 924 based on a model input 922 can be in the form of an input-output pair and a score or can simply include the highest scoring input-output pair. The output can be stored in a data storage for subsequent lookup or provided to one or more downstream systems, processes, devices, frameworks, and/or services.

The machine learning model 924 can be configured and implemented as a network service. For example, the machine learning model 924 can be configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the machine learning model 924 and/or its output can be hosted on one or more servers and/or data storage devices for accessibility to one or more requesting processes, systems, devices, frameworks, or services.

The examples shown in FIG. 9C and the accompanying description, above are provided for illustration purposes. This disclosure is not limited to the described examples. Additional or alternative details and implementations are described herein.

FIG. 9D is a block diagram of a machine learning model that can be used by and/or included in a content retrieval system in accordance with some embodiments of the present disclosure.

A specific example of a machine learning model is a deep neural network. Some machine learning models, such as multi-task models, can include multiple interconnected deep neural networks. In the example of FIG. 9D, a machine learning system 930 includes a deep neural network 934. The deep neural network 934 can be configured via training, calibration, and validation processes such as those described with reference to FIG. 9A. Some embodiments of the deep neural network 934 can be configured as a discriminative model and/or a generative model. For example, in some embodiments, a deep neural network 934 can perform both discriminative and generative tasks.

In computer science, deep learning refers to a class of machine learning that uses computer-implemented neural networks to generate predictive output, where the neural networks have one or more internal (or hidden) layers between and in addition to an input layer and an output layer. Each layer in a deep neural network (or deep learning model) performs a set of computational operations on the input to that layer.

Each layer of the neural network includes a set of nodes that each apply an activation function to one or more portions of the input to that layer to produce an output. The activation function performs a nonlinear transformation of the input and sends its output to the next layer of the network. For example, if the output of the activation function is equal to or exceeds a threshold value, the node passes its output to the next layer, but if the output is less than the threshold value, the output passed to the next layer is zero or a null value. The type of activation function used at a node or layer is selected based on the particular predictive task for which the model is configured and/or based on the model architecture. Examples of activation functions include the SoftMax function (for multi-class classification), the sigmoid function (for internal layers), and rectifier (e.g., ramp, ReLU (Rectified Linear Unit)) functions.

The input layer of a deep neural network receives and processes the model input, which can include raw data and/or pre-processed data such as aggregations, derivations, embeddings or vector representations of raw data. The output of a layer of the neural network can be connected to and used as the input to another layer, such that each layer of the deep learning model creates a different (e.g., progressively more highly processed) set of information relating to the original, raw input (e.g., producing a different representation of the raw input at each layer). Weights are applied to the output of each node of each layer before the output is propagated to the next layer. The weight values can be adjusted so that the outputs of some nodes or layers influences the final output more or less than the outputs of other nodes or layers. The output layer of the neural network produces the final predictive output, which can be made accessible to one or more downstream models, applications, systems, operations, processes or services.

Backpropagation is an example of a method that can be used to train a neural network model. In a feedforward step, the training data is propagated from the input layer through the internal layers to the final output by computing each successive layer's outputs up to and including the final output. A loss function (or cost function, such as cross-entropy, log loss, or squared error loss, or a logistic function) is used to compute error for the final output, for example, based on a comparison of the difference between the output predicted by the model and the expected or target output to the error computed on a previous iteration. The model weights (or parameters or coefficients) are adjusted to reduce the error, iteratively, until the error falls within an acceptable range or the error stops changing by more than a threshold amount (e.g., the model converges). In backpropagation, these iterative weight adjustments are propagated backward from the output layer through the internal layers. The gradient of the loss function or gradient descent (e.g., stochastic gradient descent) may be used in backpropagation.

Recommendation systems, for example, can apply deep learning models to generate predictive output and use the predictive output to configure one or more downstream operations. For example, recommendation systems compute statistical or probabilistic predictions that can be used to select, rank, or sort digital content items for presentation to users via electronic devices. Examples of downstream operations that can use the predictive output of deep learning recommendation systems include news feeds, automated product recommendations, and automated connection (e.g., friend, follower, or contact) recommendations for online platforms such as social networks. Other examples include systems that support human decision making, such as systems that use artificial intelligence to generate recommendations for health care, financial services, training, education, and/or other fields or topics. Still other examples include control systems that use artificial intelligence to recommend courses of action to other components of automated systems in operational environments, such as “smart” vehicles, appliances, robots, and other automated devices.

In the example of FIG. 9D, the deep neural network 934 includes an input layer 935, one or more hidden layers 936, and an output layer 937. The input layer 935 receives one or more batches of model input 923 (e.g., input feature sets X). For example, the input layer 935 can include a number of nodes that corresponds to the number of input features in a given input feature set X. The output of the input layer 935 becomes the input to the one or more hidden layers 936. The output of the one or more hidden layers 936 becomes the input to the output layer 937. The output layer 937 outputs the final predictive output 938. In some embodiments, each of the layers of the deep neural network 934 is fully connected in the sense that the output of each node of each layer is connected to the input of each node of the next subsequent layer. In other embodiments, the deep neural network 934 can include portions that are not fully connected.

The deep neural network 934 can be configured and implemented as a network service. For example, the deep neural network 934 can be configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the deep neural network 934 and/or its output can be hosted on one or more servers and/or data storage devices for accessibility to one or more requesting processes, systems, devices, frameworks, or services.

The input feature set X can include numerical features, categorical features, quantitative values, qualitative values, raw features, compressed representations of raw features (e.g., vector representations or embeddings), natural language, and/or other forms of digital content. Embedding as used herein may refer to a compressed representation, e.g., a numerical representation, of data, e.g., a set of features. An embedding can encode information, e.g., a set of features associated with an entity and/or attribute, relative to an embedding space. Embeddings and embedding spaces can be generated by artificial intelligence (AI) models. An embedding can be expressed as a vector, where each dimension of the vector includes a numerical value that can be an integer or a real number. The numerical value assigned to a given dimension of the vector conveys information about the data represented by the embedding, relative to the embedding space, also referred to as a vector space. The embedding space (or vector space) includes all of the possible values of each dimension of the vector. The embedding space is defined by the way in which the AI model used to generate the vector has been trained and configured, including the training data used to train the AI model. In some implementations, train as used herein refers to an iterative process of applying an AI algorithm to one or more sets of training data, analyzing the output of the AI model in comparison to expected model output using a loss function (also referred to as a cost function or error function), adjusting values of one or more parameters and/or coefficients of the AI model, and repeating the training process until the difference between the actual model output and the expected model output falls within an acceptable range of error or tolerance.

Embedding-based retrieval (EBR) is a method of searching for similar digital content, such as documents or portions of documents. Embedding-based retrieval involves converting digital data, e.g., sets of features, to embeddings and then using a similarity algorithm, such as nearest-neighbor search or cosine similarity, to identify embeddings that are similar to one another. Similarly, match or map as used herein can refer to an exact match or an inexact match. For example, match or map can refer to a machine-determined predicted or estimated degree of relevance, similarity or compatibility between entities or data items that satisfies (e.g., meets or exceeds) a threshold level of relevance, similarity or compatibility, where the threshold level of relevance, similarity or compatibility is variable based on the requirements of a particular design or implementation. The threshold level of similarity may be set lower or higher for different types of matching or mapping.

In response to an instance of feature set X, deep neural network 934 computes and outputs a predictive output 938. The predictive output 938 can be stored in a data storage for subsequent lookup or provided to one or more downstream systems, processes, devices, frameworks, and/or services.

The deep neural network 934 can be configured and implemented as a network service. For example, the deep neural network 934 can be configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the machine learning model and/or its output can be hosted on one or more servers and/or data storage devices for accessibility to one or more requesting processes, systems, devices, frameworks, or services.

The examples shown in FIG. 9D and the accompanying description, above are provided for illustration purposes. This disclosure is not limited to the described examples. Additional or alternative details and implementations are described herein.

FIG. 9E is a block diagram of a machine learning model that can be used by and/or included in a content retrieval system in accordance with some embodiments of the present disclosure.

A specific example of a deep neural network is a sequence to sequence model, which takes sequential data such as words, phrases, or images (sequences of characters, tokens, or pixel values) or time series data as input and outputs sequential data. An example of a sequence to sequence model is an encoder-decoder model. In an encoder-decoder model, a first neural network known as an encoder transforms the model input into an encoded version of the model input, e.g., an embedding or vector. For example, an encoder can transform a sentence or an image into a sequence of numbers. A second neural network known as the decoder takes the output of the encoder (e.g., the encoded version of the model input) and decodes it. For example, a decoder can transform the sequence of numbers created by the encoder into a translated sentence or another form of output. The encoder-decoder model is suitable for sequence-to-sequence problems such as computer vision and natural language processing (NLP) tasks such as machine translation.

A specific example of an encode-decoder model is a transformer model. A transformer model is a deep neural network encoder-decoder model that uses a technique called attention or self-attention to detect relationships and dependencies among data elements in a sequence. Transformer models can be applied to various NLP tasks and other machine learning tasks, such as generating content based on input attributes or tokens. For example, the attention mechanism can facilitate the detection of semantic relationships and contextual dependencies between words and phrases.

In the example of FIG. 9E, a machine learning system 940 includes a transformer model 942. The transformer model 942 is constructed using a neural network-based machine learning model architecture. In some embodiments, the neural network-based architecture includes one or more self-attention layers (e.g., multi-head attention layer 945, masked multi-head attention layer 955, and multi-head attention layer 957) that allow the model to assign different weights to different features included in the model input. Alternatively, or in addition, the neural network architecture includes feed-forward layers (e.g., feed-forward layer 947 and feed-forward layer 959) and residual connections (e.g., add & norm layer 946, add & norm layer 948, add & norm layer 956, add & norm layer 958, add & norm layer 960) that allow the model to machine-learn complex data patterns including relationships between different states, actions, and rewards in multiple different contexts. In some embodiments, transformer model 942 is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the user trajectory processing system.

As shown in FIG. 9E, transformer model 942 feeds embedded subsequences 950 into encoder 944 and decoder 954. For example, transformer model 942 feeds inputs of embedded subsequences 950 into multi-head attention layer 945 of encoder 944. In some embodiments, inputs of embedded subsequences 950 are a series of tokens and the output of the encoder (e.g., encoder output representation 952), is a fixed-dimensional representation for each of the tokens of embedded subsequences 950 including an embedding for inputs of embedded subsequences 950. Transformer model 942 feeds encoder output representation 952 and outputs of embedded subsequences 950 into decoder 954 which generates a sequence of tokens based on encoder output representation 952 and the input embeddings. While a specific architecture of encoder 944 and decoder 954 is shown for simplicity, as explained above, the exact number and arrangement of layers of each type as well as the hyperparameter values used to configure the model are determined based on the requirements of a particular design or implementation. Transformer model 942 can therefore include different numbers, arrangements, and types of layers, such that each input token of embedded subsequences 950 is fed through the layers of transformer model 942 and is dependent on other input tokens of embedded subsequences 950.

Transformer model 942 illustrates a generic encoder/decoder model for simplicity. In such a model, encoder 944 encodes the input into a fixed-length vector (e.g., encoder output representation 952) and decoder 954 decodes the fixed-length vector into an output sequence. Encoder 944 and decoder 954 are trained together to maximize the conditional log-likelihood of the output given the input. For example, once trained, encoder 944 and decoder 954 can generate an output given an input sequence or can score a pair of input/output sequences based on their probability of coexistence.

As shown in FIG. 9E, encoder 944 includes multi-head attention layer 945, add & norm layer 946, feed-forward layer 947, and add & norm layer 948. Multi-head attention layer 945 receives inputs of embedded subsequences 950 and computes output representations for each of the input tokens of embedded subsequences 950 based on the inputs of embedded subsequences 950. For example, multi-head attention layer 945 converts each input token of embedded subsequences 950 into queries, keys, and values using query, key, and value matrices. Multi-head attention layer 945 computes the output representation of the input tokens of embedded subsequences 950 as the weighted sum of the values of all of the input tokens of embedded subsequences 950. Multi-head attention layer 945 computes the weights for the weighted sum by applying a compatibility function to the corresponding key and query for the value. For example, multi-head attention layer 945 uses a scaled dot product on the key and query of an input token to determine a weight to apply to a value of the input token. Multi-head attention layer 945 includes multiple attention blocks which each compute an output representation for the input token. Multi-head attention layer 945 aggregates the output representations of these attention blocks to generate a final output representation for multi-head attention layer 945.

Inputs of embedded subsequences 950 includes the state of the online system at a given timestamp and the action taken at that state. For example, inputs of embedded subsequences 950 includes the state features and actions of embedded subsequences 950. Transformer model 942 feeds the output representation generated by multi-head attention layer 945 and residual connections from the inputs of embedded subsequences 950 into add & norm layer 948. By including these residual connections, transformer model 942 ensures that it does not “forget” features of embedded subsequences 950 during training. Forgetting in the context of machine learning can mean that as the model continues to be sequentially trained on different datasets, the model continually adjusts the values of feature coefficients based on the most recent datasets, thereby losing or diluting the effect on those coefficient values of the datasets used earlier in training.

Add & norm layer 946 sums the output representation generated by multi-head attention layer 945 and the residual connections from inputs of embedded subsequences 950 and applies a layer normalization to the result. In some embodiments, the add & normal layers also apply a SoftMax function to generate action probabilities for the inputs of embedded subsequences 950. For example, add & norm layer 946 generates estimated probabilities \hat{p}(aₖ|s), where aₖ is the action policy and s is the state features.

Transformer model 942 feeds the normalized output of add & norm layer 946 into feed-forward layer 947. Feed-forward layer 947 is a feed-forward network that receives the normalized output, feeds it through the hidden layers of feed-forward layer 947, and then feeds the output of feed-forward layer 947 into add & norm layer 948. Feed-forward layer 947 processes the information received from add & norm layer 946 and can update the hidden layers of feed-forward layer 947 based on the information (e.g., during training) and/or generate an output based on the hidden layers processing the information (e.g., during evaluation and/or inference). For example, during training, transformer model 942 updates the weights of the hidden layers of feed-forward layer 947 based on the inputs and the loss of the transformer system. Further details with regard to the loss of the transformer system as well as training objectives and metrics are discussed below. As an alternative example, during evaluation and/or inference, the weights of the hidden layers of feed-forward layer 947 are used to determine the output representation 952 of each of the input tokens of embedded subsequences 950.

Transformer model 942 feeds the output of feed-forward layer 947 into add & norm layer 948 as well as residual connections from the output of add & norm layer 946. Add & norm layer 948 sums the output of feed-forward layer 947 with the residual connections from add & norm layer 946 and applies a layer normalization to the result to generate encoder output representation 952. Transformer model 942 feeds encoder output representation 952 into multi-head attention layer 957 of decoder 954 as explained below.

Masked multi-head attention layer 955 receives outputs of embedded subsequences 950 and computes representations for each of the output tokens of embedded subsequences 950 based on masked outputs of embedded subsequences 950. For example, masked multi-head attention layer 955 computes representations for each of the output tokens of embedded subsequences 950 based on previous output tokens while masking future output tokens. Masked multi-head attention layer 955 therefore only computes representations using tokens that come before the token masked multi-head attention layer 955 is trying to predict.

Transformer model 942 feeds the representation generated by masked multi-head attention layer 955 and residual connections from the outputs of embedded subsequences 950 into add & norm layer 956. Add & norm layer 956 sums the representation generated by masked multi-head attention layer 955 and the residual connections from outputs of embedded subsequences 950 and applies a layer normalization to the result.

Transformer model 942 feeds the normalized output of add & norm layer 956 into multi-head attention layer 957. Multi-head attention layer 957 receives the normalized output of add & norm layer 956 as well as encoder output representation 952 from encoder 944 and generates a representation based on both.

Transformer model 942 feeds the representation generated by multi-head attention layer 957 and residual connections from the output of add & norm layer 956 into add & norm layer 958. Add & norm layer 958 sums the representation generated by multi-head attention layer 957 and the residual connections from the output of add & norm layer 956 and applies a layer normalization to the result.

Transformer model 942 feeds the normalized output of add & norm layer 958 into feed-forward layer 959. Feed-forward layer 959 is a feed-forward network that receives the normalized output, feeds it through the hidden layers of feed-forward layer 959, and then feeds the output of feed-forward layer 959 into add & norm layer 969. Feed-forward layer 959 processes the information received from add & norm layer 958 and can update the hidden layers of feed-forward layer 959 based on the information (e.g., during training) and/or generate an output based on the hidden layers processing the information (e.g., during evaluation and/or inference). For example, during training, transformer model 942 updates the weights of the hidden layers of feed-forward layer 959 based on the inputs and the loss of the transformer system. Further details with regard to the loss of the transformer system as well as training objectives and metrics are discussed below. As an alternative example, during evaluation and/or inference, the weights of the hidden layers of feed-forward layer 959 are used to determine the output of feed-forward layer 959.

Transformer model 942 feeds the output of feed-forward layer 959 into add & norm layer 960 as well as residual connections from the output of add & norm layer 958. Add & norm layer 960 sums the output of feed-forward layer 959 with the residual connections from add & norm layer 958 and applies a layer normalization to the result to generate an output.

Transformer model 942 generates output probabilities 962 from the output of add & norm layer 960. For example, transformer model 942 applies a linear transformation and a SoftMax function to the output of add & norm layer 960 to generate a normalized vector of output probabilities 962.

In some embodiments, such as during training, transformer model 942 determines a loss for the system based on output probabilities 962. For example, transformer model 942 uses deep quantile regression for training. In such an example, output probabilities 962 includes a mean prediction probability and estimations for the upper and lower bounds of the range of prediction such that output probabilities 926 includes an uncertainty range. In one embodiment, the loss function of transformer model 942 using deep quantile regression is represented by the following equation:

$$ℒ ( {ξ}_{i} \vert α ) = \{ \begin{matrix}{αξ}_{i} & if {ξ}_{i} \geq 0 , \\ ( α - 1 ) {ξ}_{i} & if {ξ}_{i} < 0\end{matrix} ,$$

where α is the required quantile (a value between 0 and 1 representing the desired quantile) and ξᵢ=γᵢ−f(xᵢ), where f(xᵢ) is the mean predicted by output probabilities 962, yᵢ are the outputs of embedded subsequences 950 and xᵢ are the inputs of embedded subsequences 950. The loss over the entirety of a dataset of embedded subsequences 950 where embedded subsequences 950 has a length of N can be represented by the following equation:

$$ℒ ( y , f \vert α ) = \frac{1}{N} {\sum }_{i = 1}^{N} ℒ ( {y}_{i} - f ( {x}_{i} ) \vert α ) .$$

In such embodiments, output probabilities 962 includes three values: a mean prediction, a lower bound quantile, and an upper bound quantile. In some embodiments, transformer model 942 uses upper confidence bound or Thompson sampling. For example, transformer model 942 can determine model output 964 based on the mean prediction, the lower bound quantile, and the upper bound quantile based on upper confidence bound and/or Thompson sampling.

In some embodiments, transformer model 942 is trained to optimize the model parameters with trajectory-specific normalizations using cross-entropy loss. For example, transformer model 942 uses a loss function represented by the following equation:

$$L ( θ ) = \frac{1}{{N}_{traj}} {\sum }_{i}^{{N}_{traj}} {\sum }_{t = 1}^{{T}_{i}} {w}_{i} {\sum }_{k} log ( \hat{p} ( {a}_{k}^{( it )} \vert {s}^{( it )} ) ) ,$$

where Nₜᵣₐⱼ is the trajectory count, wᵢ is the normalization weight, aₖ^{(it)} is the predicted action for the trajectory i at timestep t, and s^{(it)} is the state of the online system for the trajectory i at timestep t. In some embodiments, transformer model 942 uses trajectory-wise normalization. For example, the add & norm layers of transformer model 942 normalize the weights according to the following equation:

$${w}_{i} = \frac{1}{{T}_{i}} ,$$

where Tᵢ is the length of trajectory i. In some embodiments, transformer model 942 uses global normalization. For example, the add & norm layers of transformer model 942 normalize the weights according to the following equation: wᵢ=c, where c is a positive scalar. In some embodiments, the scalar c is predetermined.

Language models, including large language models and other generative models, can be implemented using transformer models. A generative model can be constructed using a neural network-based machine learning model architecture. In some implementations, the neural network-based architecture includes one or more input layers that receive task descriptions (or prompts), generate one or more embeddings based on the task descriptions, and pass the one or more embeddings to one or more other layers of the neural network. In other implementations, the one or more embedding are generated based on the task description by a pre-processor, the embeddings are input to the generative language model, and the generative language model outputs digital content, e.g., natural language text or a combination of natural language text and non-text output, based on the embeddings.

The neural network-based machine learning model architecture of the generative model can include one or more self-attention layers that allow the model to assign different weights to different portions of the model input (e.g., different words or phrases included in the model input). Alternatively or in addition, the neural network architecture includes feed-forward layers and residual connections that allow the model to machine-learn complex data patterns including relationships between different words or phrases in multiple different contexts. The language model or other type of generative model can be constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation.

In some examples, the neural network-based machine learning model architecture of a generative model includes or is based on one or more generative transformer models, one or more generative pre-trained transformer (GPT) models, one or more bidirectional encoder representations from transformers (BERT) models, one or more large language models (LLMs), one or more XLNet models, and/or one or more other natural language processing (NL) models that significantly advance the state-of-the-art in various linguistic tasks such as machine translation, sentiment analysis, question answering and sentence similarity. In some examples, the neural network-based machine learning model architecture includes or is based on one or more predictive content neural models that can receive digital content input and generate one or more outputs based on processing the digital content with one or more neural network models. Examples of predictive neural models include, but are not limited to, Generative Pre-Trained Transformers (GPT), BERT, and/or Recurrent Neural Networks (RNNs). In some examples, one or more types of neural network-based machine learning model architecture includes or is based on one or more multimodal neural networks capable of outputting different modalities (e.g., text, image, sound, etc.) separately and/or in combination based on digital content input. Accordingly, in some examples, a multimodal neural network is capable of outputting digital content that includes a combination of two or more of text, images, video or sound.

A generative language model can be trained on a large dataset of natural language text. For example, training samples of natural language text extracted from publicly available data sources can be used to train a generative language model. The size and composition of the dataset used to train the generative language model can vary according to the requirements of a particular design or implementation. In some implementations, the dataset used to train the generative language model includes hundreds of thousands to millions or more different natural language text training samples. In some embodiments, a generative language model includes multiple generative language models trained on differently sized datasets. For example, a generative language model can include a comprehensive but low capacity model that is trained on a large data set and used for generating examples, and the same generative language model also can include a less comprehensive but high capacity model that is trained on a smaller data set, where the high capacity model is used to generate outputs based on examples obtained from the low capacity model. In some implementations, reinforcement learning is used to further improve the output of the generative language model. In reinforcement learning, ground-truth examples of desired model output are paired with respective prompts, and these prompt-output pairs are used to train or fine tune the generative language model.

Prompt engineering is a technique used to optimize the structure and/or content of a prompt input to a generative model. Some prompts can include examples of outputs to be generated by the generative model (e.g., few-shot prompts), while other prompts can include no examples of outputs to be generated by the generative model (e.g., zero-shot prompts). Chain of thought prompting is a prompt engineering technique where the prompt includes a request that the model explain reasoning in the output. For example, the generative model performs the task described in the prompt using a series of steps and outputs reasoning as to each step performed.

Supervised learning is a method of training (or fine-tuning) a machine learning model given input-output pairs, where the output of the input-output pair is known (e.g., an expected output, a labeled output, a ground truth). Other training methods including semi-supervised learning or federated learning can be used to train a machine learning model or to fine-tune a pretrained machine learning model.

To train or fine tune a language model, a prompt is provided as input to the machine learning model. The prompt can include natural language instructions, queries, examples, etc. The machine learning model generates output by applying the weights and nodes of the machine learning model to the prompt. Error can be determined by comparing the model output to a reference or expected output. For example, the similarity between the model output and the expected output is evaluated using a similarity metric or model performance metric. The error is used to adjust the value of weights in a weight matrix included in the machine learning model and/or the number of layers and/or arrangement of layers included in the machine learning model.

A machine learning model can be trained using a backpropagation algorithm. The backpropagation algorithm operates by propagating the error through each of the algorithmic weights of the machine learning model such that the algorithmic weights are adjusted based on the amount of error. The error can be calculated at each iteration, batch, and/or epoch. The error is computed using a loss function. An example loss function includes the cross-entropy error function. After a number of training iterations, the machine learning model iteratively converges, e.g., adjusts weight values over time until the model output achieves an acceptable level of accuracy or reliability (e.g., accuracy satisfies a defined tolerance or confidence level). The values of the weights of the trained model (e.g., after convergence) are stored such that the machine learning model can be deployed during inference time.

The machine learning model 942 can be configured and implemented as a network service. For example, the machine learning model 932 can be configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the machine learning model 942 and/or its output can be hosted on one or more servers and/or data storage devices for accessibility to one or more requesting processes, systems, devices, frameworks, or services.

The examples shown in FIG. 9E and the accompanying description, above are provided for illustration purposes. This disclosure is not limited to the described examples. Additional or alternative details and implementations are described herein.

FIG. 10 is a block diagram of an example computer system including components of a content retrieval system in accordance with some embodiments of the present disclosure.

In FIG. 10, an example machine of a computer system 1000 is shown, within which a set of instructions for causing the machine to perform any of the methodologies discussed herein can be executed. In some embodiments, the computer system 1000 can correspond to a component of a networked computer system (e.g., as a component of the computer system 800 of FIG. 8) that includes, is coupled to, or utilizes a machine to execute an operating system to perform operations corresponding to one or more components of the content generation and retrieval system 880 of FIG. 8. For example, computer system 1000 corresponds to a portion of computing system 800 when the computing system is executing a portion of an application system or content generation and retrieval system 880.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a memory 1003 (e.g., flash memory, static random access memory (SRAM), etc.), an input/output system 1010, and a data storage system 1040, which communicate with each other via a bus 1030.

Processing device 1002 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 can also be at least one special-purpose processing device such as an application specific integrated circuit (ASIC), a field programmable gate array (FPGA), a digital signal processor (DSP), network processor, or the like. The processing device 1002 is configured to execute instructions 1012 for performing the operations and steps discussed herein.

In some embodiments of FIG. 10, content generation and retrieval system 1050 represents portions of an application system or content generation and retrieval system 880 while the computer system 800 is executing those portions of the application system or content generation and retrieval system 880. Instructions 1012 include portions of content generation and retrieval system 1050 when those portions of the content generation and retrieval system 1050 are being executed by processing device 1002. Thus, the content generation and retrieval system 1050 is shown in dashed lines as part of instructions 1012 to illustrate that, at times, portions of the content generation and retrieval system 1050 are executed by processing device 1002. For example, when at least some portion of the content generation and retrieval system 1050 is embodied in instructions to cause processing device 1002 to perform the method(s) described herein, some of those instructions can be read into processing device 1002 (e.g., into an internal cache or other memory) from main memory 1004 and/or data storage system 1040. However, it is not required that all of the content generation and retrieval system 1050 be included in instructions 1012 at the same time and portions of the content generation and retrieval system 1050 are stored in at least one other component of computer system 1000 at other times, e.g., when at least one portion of the content generation and retrieval system 1050 are not being executed by processing device 1002.

The computer system 1000 further includes a network interface device 1008 to communicate over the network 1020. Network interface device 1008 provides a two-way data communication coupling to a network. For example, network interface device 1008 can be an integrated-services digital network (ISDN) card, cable modem, satellite modem, or a modem to provide a data communication connection to a corresponding type of telephone line. As another example, network interface device 1008 can be a local area network (LAN) card to provide a data communication connection to a compatible LAN. Wireless links can also be implemented. In any such implementation network interface device 1008 can send and receives electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 1000.

Computer system 1000 can send messages and receive data, including program code, through the network(s) and network interface device 1008. In the Internet example, a server can transmit a requested code for an application program through the Internet and network interface device 1008. The received code can be executed by processing device 1002 as it is received, and/or stored in data storage system 1040, or other non-volatile storage for later execution.

The input/output system 1010 includes an output device, such as a display, for example a liquid crystal display (LCD) or a touchscreen display, for displaying information to a computer user, or a speaker, a haptic device, or another form of output device. The input/output system 1010 can include an input device, for example, alphanumeric keys and other keys configured for communicating information and command selections to processing device 1002. An input device can, alternatively or in addition, include a cursor control, such as a mouse, a trackball, or cursor direction keys for communicating direction information and command selections to processing device 1002 and for controlling cursor movement on a display. An input device can, alternatively or in addition, include a microphone, a sensor, or an array of sensors, for communicating sensed information to processing device 1002. Sensed information can include voice commands, audio signals, geographic location information, haptic information, and/or digital imagery, for example.

The data storage system 1040 includes a machine-readable storage medium 1042 (also known as a computer-readable medium) on which is stored at least one set of instructions 1044 or software embodying any of the methodologies or functions described herein. The instructions 1044 can also reside, completely or at least partially, within the main memory 1004 and/or within the processing device 1002 during execution thereof by the computer system 1000, the main memory 1004 and the processing device 1002 also constituting machine-readable storage media. In one embodiment, the instructions 1044 include instructions to implement functionality corresponding to an application system, agent, or content retrieval system (e.g., portions of content generation and retrieval system 880 of FIG. 8).

Dashed lines are used in FIG. 10 to indicate that it is not required that the content retrieval system be embodied entirely in instructions 1012, 1014, and 1044 at the same time. In one example, portions of the content retrieval system are embodied in instructions 1014, which are read into main memory 1004 as instructions 1014, and portions of instructions 1012 are read into processing device 1002 as instructions 1012 for execution. In another example, some portions of the content retrieval system are embodied in instructions 1044 while other portions are embodied in instructions 1014 and still other portions are embodied in instructions 1012.

While the machine-readable storage medium 1042 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media.

The examples shown in FIG. 10 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 800, can carry out the above-described computer-implemented methods in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities.

According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Illustrative examples of the technologies disclosed herein are provided below. An embodiment of the technologies may include any of the examples described herein, or any combination of any of the examples described herein, or any combination of any portions of any of the examples described herein.

In some aspects, the techniques described herein relate to a method including: providing at least one first generative machine learning model (GMLM) instruction and an intent to a GMLM, wherein the at least one first GMLM instruction is to cause the GMLM to use the intent to generate first GMLM output, wherein the first GMLM output includes a plurality of GMLM-generated output sections; providing the first GMLM output including the plurality of GMLM-generated output sections and at least one second GMLM instruction to the GMLM, wherein the at least one second GMLM instruction is to cause the GMLM to use the intent, the plurality of GMLM-generated output sections, and a first data set to generate second GMLM output including at least one first digital element; and validating the second GMLM output by comparing the at least one first digital element to at least one second digital element, wherein the at least one second digital element is accessible via a second data set.

In some aspects, the techniques described herein relate to a method, wherein the first data set includes training data used to train the GMLM, the second data set is different from the first data set, and the at least one second GMLM instruction is to induce artificial intelligence hallucination by the GMLM during generation of the at least one first digital element by excluding the second data set from the at least one second GMLM instruction.

In some aspects, the techniques described herein relate to a method, wherein comparing the at least one first digital element to the at least one second digital element includes providing at least one third GMLM instruction to the GMLM, wherein the at least one third GMLM instruction is to cause the GMLM to perform embedding-based retrieval using the at least one first digital element output by the GMLM and the second data set.

In some aspects, the techniques described herein relate to a method, wherein the at least one first GMLM instruction identifies a knowledge map and the at least one first GMLM instruction is to cause the GMLM to use the knowledge map to at least one of classify at least one user input as the intent, generate the first GMLM output, or generate at least one of the GMLM-generated output sections.

In some aspects, the techniques described herein relate to a method, further including: determining that execution of at least one first GMLM instruction by the GMLM does not meet or exceed at least one performance criterion related to at least one of the first GMLM output or the GMLM; revising the at least one first GMLM instruction to produce at least one revised first GMLM instruction until the at least one revised first GMLM instruction meets or exceeds the at least one performance criterion, wherein the at least one revised first GMLM instruction includes at least one of a greater number of instructions than the first GMLM instruction or a lesser number of instructions than the first GMLM instruction; and causing the GMLM to use the at least one revised first GMLM instruction to generate and output the first GMLM output.

In some aspects, the techniques described herein relate to a method, further including: receiving user feedback related to at least one of the first GMLM output, at least one GMLM-generated output section, or the at least one second digital element; using the received user feedback to revise at least one of the at least one first GMLM instruction or the at least one second GMLM instruction to produce at least one revised GMLM instruction; and causing the GMLM to use the at least one revised GMLM instruction to generate and output the at least one of the first GMLM output, at least one GMLM-generated output section, or the at least one second digital element.

In some aspects, the techniques described herein relate to a method, further including: determining that the at least one first digital element meets or exceeds at least one validation criterion; and including the at least one second digital element in the first GMLM output.

In some aspects, the techniques described herein relate to a method, further including: determining that the at least one first digital element does not meet or exceed at least one validation criterion; and excluding the at least one first digital element from the first GMLM output.

In some aspects, the techniques described herein relate to a method, further including: determining that the first GMLM output meets or exceeds at least one validation criterion; and causing the first GMLM output including the at least one second digital element to be presented via a device.

In some aspects, the techniques described herein relate to a method, further including: receiving at least one user input via a device; including the at least one user input in the at least one first generative machine learning model (GMLM) instruction; and causing the first GMLM output including the at least one second digital element to be presented via the device in response to the at least one user input.

In some aspects, the techniques described herein relate to a method, further including: receiving at least one user input via a device, wherein the at least one user input relates to a goal of a user of an online system; identifying digital data including at least one attribute of the user, wherein the at least one attribute is associated with the goal and includes at least one of a career stage, a job title, or an industry; including the at least one of the career stage, the job title, or the industry associated with the goal in the at least one first generative machine learning model (GMLM) instruction; and causing the first GMLM output including the at least one second digital element to be presented via the device in response to the at least one user input, wherein the first GMLM output relates to the goal, the plurality of GMLM-generated output sections include activities related to achievement of the goal, and the at least one second digital element includes at least one of a content item, an event, or a recommendation.

In some aspects, the techniques described herein relate to a system including: at least one processor; and at least one memory coupled to the at least one processor, wherein the at least one memory includes at least one instruction that, when executed by the at least one processor, is capable of causing the at least one processor to perform at least one operation including: providing at least one first generative machine learning model (GMLM) instruction and an intent to a GMLM, wherein the at least one first GMLM instruction is to cause the GMLM to use the intent to generate first GMLM output, wherein the first GMLM output includes a plurality of GMLM-generated output sections; providing the first GMLM output including the plurality of GMLM-generated output sections and at least one second GMLM instruction to the GMLM, wherein the at least one second GMLM instruction is to cause the GMLM to use the intent, the plurality of GMLM-generated output sections, and a first data set to generate second GMLM output including at least one first digital element; and validating the second GMLM output by comparing the at least one first digital element to at least one second digital element, wherein the at least one second digital element is accessible via a second data set.

In some aspects, the techniques described herein relate to a system, wherein the first data set includes training data used to train the GMLM, the second data set is different from the first data set, and the at least one second GMLM instruction is to induce artificial intelligence hallucination by the GMLM during generation of the at least one first digital element by excluding the second data set from the at least one second GMLM instruction.

In some aspects, the techniques described herein relate to a system, wherein comparing the at least one first digital element to the at least one second digital element includes providing at least one third GMLM instruction to the GMLM, wherein the at least one third GMLM instruction is to cause the GMLM to perform embedding-based retrieval using the at least one first digital element output by the GMLM and the second data set.

In some aspects, the techniques described herein relate to a system, wherein the at least one operation further includes: determining that execution of at least one first GMLM instruction by the GMLM does not meet or exceed at least one performance criterion related to at least one of the first GMLM output or the GMLM; revising the at least one first GMLM instruction to produce at least one revised first GMLM instruction until the at least one revised first GMLM instruction meets or exceeds the at least one performance criterion, wherein the at least one revised first GMLM instruction includes at least one of a greater number of instructions than the first GMLM instruction or a lesser number of instructions than the first GMLM instruction; and causing the GMLM to use the at least one revised first GMLM instruction to generate and output the first GMLM output.

In some aspects, the techniques described herein relate to a system, wherein the at least one operation further includes: receiving user feedback related to at least one of the first GMLM output, at least one GMLM-generated output section, or the at least one second digital element; using the received user feedback to revise at least one of the at least one first GMLM instruction or the at least one second GMLM instruction to produce at least one revised GMLM instruction; and causing the GMLM to use the at least one revised GMLM instruction to generate and output the at least one of the first GMLM output, at least one GMLM-generated output section, or the at least one second digital element.

In some aspects, the techniques described herein relate to at least one non-transitory computer readable medium including at least one instruction that, when executed by at least one processor, is capable of causing the at least one processor to: provide at least one first generative machine learning model (GMLM) instruction and an intent to a GMLM, wherein the at least one first GMLM instruction is to cause the GMLM to use the intent to generate first GMLM output, wherein the first GMLM output includes a plurality of GMLM-generated output sections; provide the first GMLM output including the plurality of GMLM-generated output sections and at least one second GMLM instruction to the GMLM, wherein the at least one second GMLM instruction is to cause the GMLM to use the intent, the plurality of GMLM-generated output sections, and a first data set to generate second GMLM output including at least one first digital element; and validate the second GMLM output by comparing the at least one first digital element to at least one second digital element, wherein the at least one second digital element is accessible via a second data set.

In some aspects, the techniques described herein relate to an at least one non-transitory computer readable medium, wherein the at least one instruction, when executed by at least one processor, is capable of causing the at least one processor to: receive at least one user input via a device; include the at least one user input in the at least one first generative machine learning model (GMLM) instruction; and cause the first GMLM output including the at least one second digital element to be presented via the device in response to the at least one user input.

In some aspects, the techniques described herein relate to an at least one non-transitory computer readable medium, wherein the at least one instruction, when executed by at least one processor, is capable of causing the at least one processor to: receive at least one user input via a device, wherein the at least one user input relates to a goal of a user of an online system; identify digital data including at least one attribute of the user, wherein the at least one attribute is associated with the goal and includes at least one of a career stage, a job title, or an industry; include the at least one of the career stage, the job title, or the industry associated with the goal in the at least one first generative machine learning model (GMLM) instruction; and cause the first GMLM output including the at least one second digital element to be presented via the device in response to the at least one user input, wherein the first GMLM output relates to the goal, the plurality of GMLM-generated output sections include activities related to achievement of the goal, and the at least one second digital element includes at least one of a content item, an event, or a recommendation.

In some aspects, the techniques described herein relate to an at least one non-transitory computer readable medium, wherein the first data set includes training data used to train the GMLM, the second data set is different from the first data set, and the at least one second GMLM instruction is to induce artificial intelligence hallucination by the GMLM during generation of the at least one first digital element by excluding the second data set from the at least one second GMLM instruction.

In some aspects, the techniques described herein relate to a method including: providing at least one first generative machine learning model (GMLM) instruction and an intent to a GMLM, wherein the at least one first GMLM instruction is to cause the GMLM to use the intent to generate first GMLM output, wherein the first GMLM output includes a plurality of GMLM-generated output sections; providing the first GMLM output including the plurality of GMLM-generated output sections and at least one second GMLM instruction to the GMLM, wherein the at least one second GMLM instruction is to cause the GMLM to use the intent, the plurality of GMLM-generated output sections, and a first data set to generate second GMLM output including at least one first digital element; and validating the second GMLM output by comparing the at least one first digital element to at least one second digital element, wherein the at least one second digital element is accessible via a second data set.

In some aspects, the techniques described herein relate to a method, wherein the first data set includes training data used to train the GMLM, the second data set is different from the first data set, and the at least one second GMLM instruction is to induce artificial intelligence hallucination by the GMLM during generation of the at least one first digital element by excluding the second data set from the at least one second GMLM instruction.

In some aspects, the techniques described herein relate to a method, wherein comparing the at least one first digital element to the at least one second digital element includes providing at least one third GMLM instruction to the GMLM, wherein the at least one third GMLM instruction is to cause the GMLM to perform embedding-based retrieval using the at least one first digital element output by the GMLM and the second data set.

In some aspects, the techniques described herein relate to a method, wherein the at least one first GMLM instruction identifies a knowledge map and the at least one first GMLM instruction is to cause the GMLM to use the knowledge map to at least one of classify at least one user input as the intent, generate the first GMLM output, or generate at least one of the GMLM-generated output sections.

In some aspects, the techniques described herein relate to a method, further including: determining that execution of at least one first GMLM instruction by the GMLM does not meet or exceed at least one performance criterion related to at least one of the first GMLM output or the GMLM; revising the at least one first GMLM instruction to produce at least one revised first GMLM instruction until the at least one revised first GMLM instruction meets or exceeds the at least one performance criterion, wherein the at least one revised first GMLM instruction includes at least one of a greater number of instructions than the first GMLM instruction or a lesser number of instructions than the first GMLM instruction; and causing the GMLM to use the at least one revised first GMLM instruction to generate and output the first GMLM output.

In some aspects, the techniques described herein relate to a method, further including: receiving user feedback related to at least one of the first GMLM output, at least one GMLM-generated output section, or the at least one second digital element; using the received user feedback to revise at least one of the at least one first GMLM instruction or the at least one second GMLM instruction to produce at least one revised GMLM instruction; and causing the GMLM to use the at least one revised GMLM instruction to generate and output the at least one of the first GMLM output, at least one GMLM-generated output section, or the at least one second digital element.

In some aspects, the techniques described herein relate to a method, further including: determining that the at least one first digital element meets or exceeds at least one validation criterion; and including the at least one second digital element in the first GMLM output.

In some aspects, the techniques described herein relate to a method, further including: determining that the at least one first digital element does not meet or exceed at least one validation criterion; and excluding the at least one first digital element from the first GMLM output.

In some aspects, the techniques described herein relate to a method, further including: determining that the first GMLM output meets or exceeds at least one validation criterion; and causing the first GMLM output including the at least one second digital element to be presented via a device.

In some aspects, the techniques described herein relate to a method, further including: receiving at least one user input via a device; including the at least one user input in the at least one first generative machine learning model (GMLM) instruction; and causing the first GMLM output including the at least one second digital element to be presented via the device in response to the at least one user input.

In some aspects, the techniques described herein relate to a method, further including: receiving at least one user input via a device, wherein the at least one user input relates to a goal of a user of an online system; identifying digital data including at least one attribute of the user, wherein the at least one attribute is associated with the goal and includes at least one of a career stage, a job title, or an industry; including the at least one of the career stage, the job title, or the industry associated with the goal in the at least one first generative machine learning model (GMLM) instruction; and causing the first GMLM output including the at least one second digital element to be presented via the device in response to the at least one user input, wherein the first GMLM output relates to the goal, the plurality of GMLM-generated output sections include activities related to achievement of the goal, and the at least one second digital element includes at least one of a content item, an event, or a recommendation.

In some aspects, the techniques described herein relate to a method including: providing at least one first generative machine learning model (GMLM) instruction and an intent to a GMLM, wherein the at least one first GMLM instruction is to cause the GMLM to use the intent to generate and output a plan related to the intent, wherein the plan includes a plurality of GMLM-generated plan sections; providing the plan including the plurality of GMLM-generated plan sections and at least one second GMLM instruction to the GMLM, wherein the at least one second GMLM instruction is to cause the GMLM to use the plurality of GMLM-generated plan sections and a first data set to generate and output first digital elements related to the plan; and validating the at least one GMLM-generated first digital element by comparing the at least one GMLM-generated first digital element to at least one digital element of a second data set.

In some aspects, the method includes, in response to the at least one GMLM-generated first digital element meeting or exceeding at least one validation criterion, including the at least one digital element in the plan.

In some aspects, the method includes, in response to at least one validation criterion exceeding the at least one GMLM-generated first digital element meeting, skipping the step of including the at least one digital element in the plan.

In some aspects, the method includes causing the plan including the at least one digital element to be presented via a device.

Clause 1. A method comprising: providing at least one first generative machine learning model (GMLM) instruction and an intent to a GMLM, wherein the at least one first GMLM instruction is to cause the GMLM to use the intent to generate first GMLM output, wherein the first GMLM output comprises a plurality of GMLM-generated output sections; providing the first GMLM output including the plurality of GMLM-generated output sections and at least one second GMLM instruction to the GMLM, wherein the at least one second GMLM instruction is to cause the GMLM to use the intent, the plurality of GMLM-generated output sections, and a first data set to generate second GMLM output comprising at least one first digital element; and validating the second GMLM output by comparing the at least one first digital element to at least one second digital element, wherein the at least one second digital element is accessible via a second data set.

Clause 2. The method of clause 1, wherein the first data set comprises training data used to train the GMLM, the second data set is different from the first data set, and the at least one second GMLM instruction is to induce artificial intelligence hallucination by the GMLM during generation of the at least one first digital element by excluding the second data set from the at least one second GMLM instruction.

Clause 3. The method of clause 1 or clause 2, wherein comparing the at least one first digital element to the at least one second digital element comprises providing at least one third GMLM instruction to the GMLM, wherein the at least one third GMLM instruction is to cause the GMLM to perform embedding-based retrieval using the at least one first digital element output by the GMLM and the second data set.

Clause 4. The method of any of clauses 1-3, wherein the at least one first GMLM instruction identifies a knowledge map and the at least one first GMLM instruction is to cause the GMLM to use the knowledge map to at least one of classify at least one user input as the intent, generate the first GMLM output, or generate at least one of the GMLM-generated output sections.

Clause 5. The method of any of clauses 1-4, further comprising: determining that execution of at least one first GMLM instruction by the GMLM does not meet or exceed at least one performance criterion related to at least one of the first GMLM output or the GMLM; revising the at least one first GMLM instruction to produce at least one revised first GMLM instruction until the at least one revised first GMLM instruction meets or exceeds the at least one performance criterion, wherein the at least one revised first GMLM instruction comprises at least one of a greater number of instructions than the first GMLM instruction or a lesser number of instructions than the first GMLM instruction; and causing the GMLM to use the at least one revised first GMLM instruction to generate and output the first GMLM output.

Clause 6. The method of any of clauses 1-5, further comprising: receiving user feedback related to at least one of the first GMLM output, at least one GMLM-generated output section, or the at least one second digital element; using the received user feedback to revise at least one of the at least one first GMLM instruction or the at least one second GMLM instruction to produce at least one revised GMLM instruction; and causing the GMLM to use the at least one revised GMLM instruction to generate and output the at least one of the first GMLM output, at least one GMLM-generated output section, or the at least one second digital element.

Clause 7. The method of any of clauses 1-6, further comprising: determining that the at least one first digital element meets or exceeds at least one validation criterion; and including the at least one second digital element in the first GMLM output.

Clause 8. The method of any of clauses 1-7, further comprising: determining that the at least one first digital element does not meet or exceed at least one validation criterion; and excluding the at least one first digital element from the first GMLM output.

Clause 9. The method of any of clauses 1-8, further comprising: determining that the first GMLM output meets or exceeds at least one validation criterion; and causing the first GMLM output including the at least one second digital element to be presented via a device.

Clause 10. The method of any of clauses 1-9, further comprising: receiving at least one user input via a device; including the at least one user input in the at least one first generative machine learning model (GMLM) instruction; and causing the first GMLM output including the at least one second digital element to be presented via the device in response to the at least one user input.

Clause 11. The method of any of clauses 1-10, further comprising: receiving at least one user input via a device, wherein the at least one user input relates to a goal of a user of an online system; identifying digital data comprising at least one attribute of the user, wherein the at least one attribute is associated with the goal and comprises at least one of a career stage, a job title, or an industry; including the at least one of the career stage, the job title, or the industry associated with the goal in the at least one first generative machine learning model (GMLM) instruction; and causing the first GMLM output including the at least one second digital element to be presented via the device in response to the at least one user input, wherein the first GMLM output relates to the goal, the plurality of GMLM-generated output sections comprise activities related to achievement of the goal, and the at least one second digital element comprises at least one of a content item, an event, or a recommendation.

Clause 21. A method comprising: providing at least one first generative machine learning model (GMLM) instruction and an intent to a GMLM, wherein the at least one first GMLM instruction is to cause the GMLM to use the intent to generate and output a plan related to the intent, wherein the plan comprises a plurality of GMLM-generated plan sections; providing the plan including the plurality of GMLM-generated plan sections and at least one second GMLM instruction to the GMLM, wherein the at least one second GMLM instruction is to cause the GMLM to use the plurality of GMLM-generated plan sections and a first data set to generate and output first digital elements related to the plan; and validating the at least one GMLM-generated first digital element by comparing the at least one GMLM-generated first digital element to at least one digital element of a second data set.

Clause 22. The method of clause 1, further comprising, in response to the at least one GMLM-generated first digital element meeting or exceeding at least one validation criterion, including the at least one digital element in the plan.

Clause 23. The method of clause 1, further comprising, in response to at least one validation criterion exceeding the at least one GMLM-generated first digital element meeting, skipping the step of including the at least one digital element in the plan.

Clause 24. The method of clause 1 or clause 2, further comprising causing the plan including the at least one digital element to be presented via a device.

Clause 25. The method of clause 3, further comprising causing the plan excluding the at least one digital element to be presented via a device.

In some aspects, the techniques described herein relate to a method including: providing at least one first generative machine learning model (GMLM) instruction and an intent to a GMLM, wherein the at least one first GMLM instruction is to cause the GMLM to use the intent to generate and output a plan related to the intent, wherein the plan includes a plurality of GMLM-generated plan sections; providing the plan including the plurality of GMLM-generated plan sections and at least one second GMLM instruction to the GMLM, wherein the at least one second GMLM instruction is to cause the GMLM to use the plurality of GMLM-generated plan sections and a first data set to generate and output first digital elements related to the plan; and validating the at least one GMLM-generated first digital element by comparing the at least one GMLM-generated first digital element to at least one digital element of a second data set.

In some aspects, the method includes, in response to the at least one GMLM-generated first digital element meeting or exceeding at least one validation criterion, including the at least one digital element in the plan.

In some aspects, the method includes, in response to at least one validation criterion exceeding the at least one GMLM-generated first digital element meeting, skipping the step of including the at least one digital element in the plan.

In some aspects, the method includes causing the first GMLM output including the at least one digital element to be presented via a device.

Clause 31. A method comprising: providing at least one first generative machine learning model (GMLM) instruction and an intent to a GMLM, wherein the at least one first GMLM instruction is to cause the GMLM to use the intent to generate first GMLM output related to the intent; providing the first GMLM output and at least one second GMLM instruction to the GMLM, wherein the at least one second GMLM instruction is to cause the GMLM to use the first GMLM output and a first data set to generate second GMLM output comprising at least one first digital element; and validating the second GMLM output by comparing the at least one first digital element to at least one digital element of a second data set.

Clause 32. The method of clause 21, further comprising, in response to the at least one first digital element meeting or exceeding at least one validation criterion, including the at least one digital element in a user interface.

Clause 33. The method of clause 21, further comprising in response to the at least one first digital element not meeting or exceeding at least one validation criterion, excluding the at least one digital element from the user interface.

Clause 34. The method of any of clauses 21-23, wherein the second data set is different from the first data set.

Clause 35. The method of any of clauses 21-24, wherein the first data set comprises training data used to train the GMLM and the second data set comprises digital content items that are distributable via at least one network or presentable via at least one device.

Clause 41. 1A. A method comprising: providing at least one first generative machine learning model (GMLM) instruction and an intent to a GMLM, wherein the at least one first GMLM instruction is to cause the GMLM to use the intent and a first data set to generate and output first digital elements related to the intent; receiving the GMLM-generated first digital elements via the GMLM; and using the GMLM-generated first digital elements to identify digital elements in a second data set.

Embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
providing at least one first generative machine learning model (GMLM) instruction and an intent to a GMLM, wherein the at least one first GMLM instruction is to cause the GMLM to use the intent to generate first GMLM output, wherein the first GMLM output comprises a plurality of GMLM-generated output sections;
providing the first GMLM output including the plurality of GMLM-generated output sections and at least one second GMLM instruction to the GMLM, wherein the at least one second GMLM instruction is to cause the GMLM to use the intent, the plurality of GMLM-generated output sections, and a first data set to generate second GMLM output comprising at least one first digital element; and
validating the second GMLM output by comparing the at least one first digital element to at least one second digital element, wherein the at least one second digital element is accessible via a second data set.

2. The method of claim 1, wherein the first data set comprises training data used to train the GMLM, the second data set is different from the first data set, and the at least one second GMLM instruction is to induce artificial intelligence hallucination by the GMLM during generation of the at least one first digital element by excluding the second data set from the at least one second GMLM instruction.

3. The method of claim 1, wherein comparing the at least one first digital element to the at least one second digital element comprises providing at least one third GMLM instruction to the GMLM, wherein the at least one third GMLM instruction is to cause the GMLM to perform embedding-based retrieval using the at least one first digital element output by the GMLM and the second data set.

4. The method of claim 1, wherein the at least one first GMLM instruction identifies a knowledge map and the at least one first GMLM instruction is to cause the GMLM to use the knowledge map to at least one of classify at least one user input as the intent, generate the first GMLM output, or generate at least one of the GMLM-generated output sections.

5. The method of claim 1, further comprising:
determining that execution of at least one first GMLM instruction by the GMLM does not meet or exceed at least one performance criterion related to at least one of the first GMLM output or the GMLM;
revising the at least one first GMLM instruction to produce at least one revised first GMLM instruction until the at least one revised first GMLM instruction meets or exceeds the at least one performance criterion, wherein the at least one revised first GMLM instruction comprises at least one of a greater number of instructions than the first GMLM instruction or a lesser number of instructions than the first GMLM instruction; and
causing the GMLM to use the at least one revised first GMLM instruction to generate and output the first GMLM output.

6. The method of claim 1, further comprising:
receiving user feedback related to at least one of the first GMLM output, at least one GMLM-generated output section, or the at least one second digital element;
using the received user feedback to revise at least one of the at least one first GMLM instruction or the at least one second GMLM instruction to produce at least one revised GMLM instruction; and
causing the GMLM to use the at least one revised GMLM instruction to generate and output the at least one of the first GMLM output, at least one GMLM-generated output section, or the at least one second digital element.

7. The method of claim 1, further comprising:
determining that the at least one first digital element meets or exceeds at least one validation criterion; and
including the at least one second digital element in the first GMLM output.

8. The method of claim 1, further comprising:
determining that the at least one first digital element does not meet or exceed at least one validation criterion; and
excluding the at least one first digital element from the first GMLM output.

9. The method of claim 1, further comprising:
determining that the first GMLM output meets or exceeds at least one validation criterion; and
causing the first GMLM output including the at least one second digital element to be presented via a device.

10. The method of claim 1, further comprising:
receiving at least one user input via a device;
including the at least one user input in the at least one first generative machine learning model (GMLM) instruction; and
causing the first GMLM output including the at least one second digital element to be presented via the device in response to the at least one user input.

11. The method of claim 1, further comprising:
receiving at least one user input via a device, wherein the at least one user input relates to a goal of a user of an online system;
identifying digital data comprising at least one attribute of the user, wherein the at least one attribute is associated with the goal and comprises at least one of a career stage, a job title, or an industry;
including the at least one of the career stage, the job title, or the industry associated with the goal in the at least one first generative machine learning model (GMLM) instruction; and
causing the first GMLM output including the at least one second digital element to be presented via the device in response to the at least one user input, wherein the first GMLM output relates to the goal, the plurality of GMLM-generated output sections comprise activities related to achievement of the goal, and the at least one second digital element comprises at least one of a content item, an event, or a recommendation.

12. A system comprising:
at least one processor; and
at least one memory coupled to the at least one processor, wherein the at least one memory comprises at least one instruction that, when executed by the at least one processor, is capable of causing the at least one processor to perform at least one operation comprising:
providing at least one first generative machine learning model (GMLM) instruction and an intent to a GMLM, wherein the at least one first GMLM instruction is to cause the GMLM to use the intent to generate first GMLM output, wherein the first GMLM output comprises a plurality of GMLM-generated output sections;
providing the first GMLM output including the plurality of GMLM-generated output sections and at least one second GMLM instruction to the GMLM, wherein the at least one second GMLM instruction is to cause the GMLM to use the intent, the plurality of GMLM-generated output sections, and a first data set to generate second GMLM output comprising at least one first digital element; and
validating the second GMLM output by comparing the at least one first digital element to at least one second digital element, wherein the at least one second digital element is accessible via a second data set.

13. The system of claim 12, wherein the first data set comprises training data used to train the GMLM, the second data set is different from the first data set, and the at least one second GMLM instruction is to induce artificial intelligence hallucination by the GMLM during generation of the at least one first digital element by excluding the second data set from the at least one second GMLM instruction.

14. The system of claim 12, wherein comparing the at least one first digital element to the at least one second digital element comprises providing at least one third GMLM instruction to the GMLM, wherein the at least one third GMLM instruction is to cause the GMLM to perform embedding-based retrieval using the at least one first digital element output by the GMLM and the second data set.

15. The system of claim 12, wherein the at least one operation further comprises:
determining that execution of at least one first GMLM instruction by the GMLM does not meet or exceed at least one performance criterion related to at least one of the first GMLM output or the GMLM;
revising the at least one first GMLM instruction to produce at least one revised first GMLM instruction until the at least one revised first GMLM instruction meets or exceeds the at least one performance criterion, wherein the at least one revised first GMLM instruction comprises at least one of a greater number of instructions than the first GMLM instruction or a lesser number of instructions than the first GMLM instruction; and
causing the GMLM to use the at least one revised first GMLM instruction to generate and output the first GMLM output.

16. The system of claim 12, wherein the at least one operation further comprises:
receiving user feedback related to at least one of the first GMLM output, at least one GMLM-generated output section, or the at least one second digital element;
using the received user feedback to revise at least one of the at least one first GMLM instruction or the at least one second GMLM instruction to produce at least one revised GMLM instruction; and
causing the GMLM to use the at least one revised GMLM instruction to generate and output the at least one of the first GMLM output, at least one GMLM-generated output section, or the at least one second digital element.

17. At least one non-transitory computer readable medium comprising at least one instruction that, when executed by at least one processor, is capable of causing the at least one processor to:
provide at least one first generative machine learning model (GMLM) instruction and an intent to a GMLM, wherein the at least one first GMLM instruction is to cause the GMLM to use the intent to generate first GMLM output, wherein the first GMLM output comprises a plurality of GMLM-generated output sections;
provide the first GMLM output including the plurality of GMLM-generated output sections and at least one second GMLM instruction to the GMLM, wherein the at least one second GMLM instruction is to cause the GMLM to use the intent, the plurality of GMLM-generated output sections, and a first data set to generate second GMLM output comprising at least one first digital element; and
validate the second GMLM output by comparing the at least one first digital element to at least one second digital element, wherein the at least one second digital element is accessible via a second data set.

18. The at least one non-transitory computer readable medium of claim 17, wherein the at least one instruction, when executed by at least one processor, is capable of causing the at least one processor to:
receive at least one user input via a device;
include the at least one user input in the at least one first generative machine learning model (GMLM) instruction; and
cause the first GMLM output including the at least one second digital element to be presented via the device in response to the at least one user input.

19. The at least one non-transitory computer readable medium of claim 17, wherein the at least one instruction, when executed by at least one processor, is capable of causing the at least one processor to:
receive at least one user input via a device, wherein the at least one user input relates to a goal of a user of an online system;
identify digital data comprising at least one attribute of the user, wherein the at least one attribute is associated with the goal and comprises at least one of a career stage, a job title, or an industry;
include the at least one of the career stage, the job title, or the industry associated with the goal in the at least one first generative machine learning model (GMLM) instruction; and
cause the first GMLM output including the at least one second digital element to be presented via the device in response to the at least one user input, wherein the first GMLM output relates to the goal, the plurality of GMLM-generated output sections comprise activities related to achievement of the goal, and the at least one second digital element comprises at least one of a content item, an event, or a recommendation.

20. The at least one non-transitory computer readable medium of claim 17, wherein the first data set comprises training data used to train the GMLM, the second data set is different from the first data set, and the at least one second GMLM instruction is to induce artificial intelligence hallucination by the GMLM during generation of the at least one first digital element by excluding the second data set from the at least one second GMLM instruction.
